(19) United States
(12) Patent Application Publication
(10) Pub. No.: US 2026/0230683 A1
(43) Pub. Date: Aug. 6, 2026

(54) UNDERSTANDING ADVERTISEMENT CREATIVES USING MACHINE LEARNING MODELS

(71) Applicant: NETFLIX, INC., Los Gatos, CA (US)

(72) Inventors: Jiaying SHI, Fremont, CA (US); Abhishek Shivratan SONI, Milpitas, CA (US); Teron SAMUEL, Jersey City, NJ (US); Edward Robin THOMAS, Los Angeles, CA (US); Venkateswara Rao KANTAMANENI, Fremont, CA (US); Sampada Madhav SONALKAR, Sunnyvale, CA (US); Terri Chia CHEN, San Jose, CA (US); Anbo CHEN, Bellevue, WA (US); Anuradha ADDANKI, Redondo Beach, CA (US); Ravi Srinivas RANGANATHAN, San Jose, CA (US)

(21) Appl. No.: 19/274,272

(22) Filed: Jul. 18, 2025

Related U.S. Application Data
(60) Provisional application No. 63/746,800, filed on Jan. 17, 2025.

(51) Int. Cl. H04N 21/81; G10L 15/183; H04N 21/858

(52) U.S. Cl. CPC H04N 21/812; G10L 15/183; H04N 21/858

(57) ABSTRACT

Techniques for generating advertisement video features and advertisement audio features include receiving an advertisement creative via one or more I/O devices; generating, based on the advertisement creative, audio data and video data; and generating, based on the audio data and the video data, and using a machine learning model, one or more video features and one or more audio features.

### CROSS-REFERENCE TO RELATED APPLICATIONS

This application claims priority benefit of the United States Provisional Patent Application titled, “TECHNIQUES FOR UNDERSTANDING advertisement CREATIVES USING MACHINE LEARNING MODELS,” filed on Jan. 17, 2025, and having Ser. No. 63/746,800. The subject matter of this related application is hereby incorporated herein by reference.

### BACKGROUND

### Technical Field

The embodiments of the present disclosure relate generally to computer science and machine learning, and more specifically, to techniques for understanding advertisement creatives using machine learning models.

### Description of the Related Art

Advertisement creative understanding refers to the process of interpreting multimedia advertisements, such as video, audio, and text-based creatives, to extract meaningful information about the content being promoted. Advertisement creative understanding includes identifying brands, classifying product categories, and detecting relevant visual and textual cues that reflect the underlying intent of the advertisement. Advertisement creative understanding plays an important role in a wide range of applications, including advertising analytics, brand safety, compliance monitoring, audience targeting, campaign optimization, and/or the like. For example, advertisement networks and marketers could analyze large volumes of advertisement creatives to assess brand exposure across platforms or to verify whether an advertisement aligns with content policies. Similarly, retailers and advertisers benefit from structured insights that reveal which products are being promoted and in what context, enabling better attribution, reporting, and automated categorization across digital ecosystems.

One conventional approach used in advertisement creative understanding includes manual workflows, in which human reviewers analyze multimedia advertisement creatives and generate descriptive tags, such as brand names, product categories, compliance indicators, and/or the like. For example, a content review team can inspect a video advertisement frame-by-frame to identify visual elements, transcribe audio dialogue, and assign appropriate labels based on internal policies or advertising standards. The human-generated tags can then be consumed by downstream systems for purposes such as advertisement targeting, frequency capping, or comparative brand separation. Another conventional approach includes semi-manual tagging systems, where tools assist with transcription or frame extraction, but the interpretation and categorization remain dependent on human judgment.

One drawback of conventional advertisement creative understanding approaches is the heavy reliance on manual reviews. Such reliance introduces inefficiencies and inconsistencies at scale. Because the conventional approaches depend on human reviewers to interpret and tag creative content, the tagging process can be time-consuming and error-prone, particularly when dealing with high volumes of diverse advertisement formats. The conventional approaches based on manual reviews often result in inconsistent classification across teams or over time, which reduces the reliability of downstream ad-serving logic such as targeting, frequency capping, and brand separation. For example, a reviewer may need to watch a 30-second video advertisement multiple times to identify brand mentions or transcribe spoken product names, resulting in delays and potential human error.

Another drawback of the above approaches is the inability to quickly adapt to new product categories or evolving content guidelines, which hinders maintaining advertisement creative understanding speed and accuracy as content and brand taxonomies grow. For example, if a new product category, such as “Electric Scooters” and/or the like, is introduced or a brand rebrands with a new visual identity, conventional approaches based on manual reviews take weeks or months to incorporate the change across all tagging operations.

As the foregoing illustrates, what is needed in the art are more effective techniques for advertisement creative understanding.

### SUMMARY

One embodiment of the present disclosure sets forth a computer-implemented method for generating advertisement video features and advertisement audio features. The method includes receiving an advertisement creative via one or more I/O devices. The method further includes generating, based on the advertisement creative, audio data and video data. Furthermore, the method includes generating, based on the audio data and the video data, and using a machine learning model, one or more video features and one or more audio features.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that the disclosed techniques enable advertisement creative understanding to be performed in an automated and scalable manner through the use of multimodal machine learning models. This approach reduces reliance on manual reviews while increasing efficiency and consistency. The disclosed techniques involve the automated extraction of visual and audio features from advertisement creatives, including video keyframes, audio transcripts, brand logos, and textual elements. A multimodal model is employed to perform brand identification, brand resolution, and product category classification with a high degree of accuracy. Consequently, the disclosed techniques permit the processing of large volumes of diverse advertisement formats in a consistent and repeatable manner, thereby reducing human intervention, processing time, and the potential for human error. Additionally, the disclosed techniques support rapid adaptation to evolving content taxonomies and new product categories by employing large language models to dynamically interpret taxonomy updates and generate model-friendly category names and definitions. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure used to distribute content to content servers and endpoint devices, according to various embodiments of the present disclosure.

FIG. 2 is a block diagram of a content server that can be implemented in conjunction with the network infrastructure of FIG. 1, according to various embodiments of the present disclosure.

FIG. 3 is a block diagram of a control server that can be implemented in conjunction with the network infrastructure of FIG. 1, according to various embodiments of the present disclosure.

FIG. 4 is a block diagram of an endpoint device that can be implemented in conjunction with the network infrastructure of FIG. 1, according to various embodiments of the present disclosure.

FIG. 5 is a block diagram of a computer-based system according to various embodiments.

FIG. 6 is a more detailed illustration of the video/audio feature generator FIG. 5, according to various embodiments.

FIG. 7 is a more detailed illustration of the keyframe identification module of FIG. 6, according to various embodiments.

FIG. 8 is a more detailed illustration of the brand alias generator of FIG. 5, according to various embodiments.

FIG. 9 is a more detailed illustration of the advertisement creative understanding application of FIG. 5, according to various embodiments.

FIG. 10 sets forth a flow diagram of method steps for generating the video/audio feature data, according to various embodiments.

FIG. 11 sets forth a flow diagram of method steps for generating the video keyframes, according to various embodiments.

FIG. 12 sets forth a flow diagram of method steps for generating brand alias table, according to various embodiments.

FIG. 13 sets forth a flow diagram of method steps for generating resolved brands, product category tree, and optionally chain-of-thought (CoT), according to various embodiments.

FIG. 14 sets forth a flow diagram of method steps for generating resolved brands, according to various embodiments.

FIG. 15 sets forth a flow diagram of method steps for generating product category tree, and optionally CoT, according to various embodiments.

### DETAILED DESCRIPTION

In the following description, numerous specific details are set forth to provide a more thorough understanding of the embodiments of the present invention. However, it will be apparent to one of skill in the art that the embodiments of the present invention may be practiced without one or more of these specific details.

### System Overview

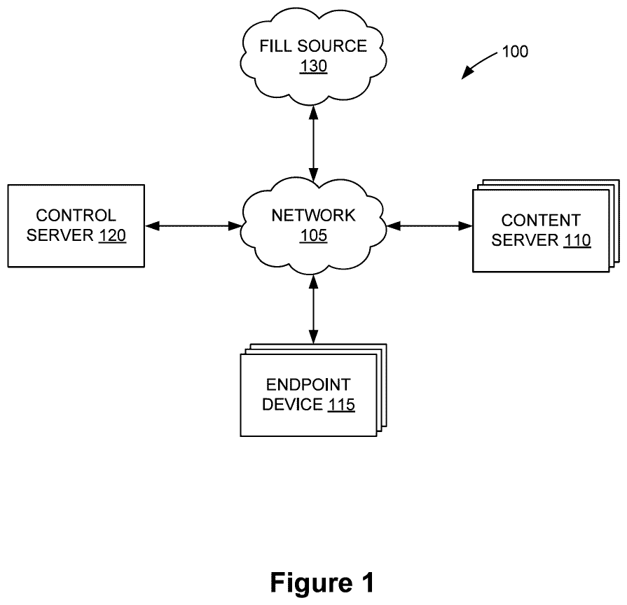

FIG. 1 illustrates a network infrastructure 100 used to distribute content to content servers 110 and endpoint devices 115, according to various embodiments of the invention. As shown, the network infrastructure 100 includes content servers 110, control server 120, and endpoint devices 115, each of which are connected via a communications network 105.

Each endpoint device 115 communicates with one or more content servers 110 (also referred to as “caches” or “nodes”) via the network 105 to download content, such as textual data, graphical data, audio data, video data, and other types of data. The downloadable content, also referred to herein as a “file,” is then presented to a user of one or more endpoint devices 115. In various embodiments, the endpoint devices 115 may include computer systems, set-top boxes, mobile computers, smartphones, tablets, console and handheld video game systems, digital video recorders (DVRs), DVD players, connected digital TVs, dedicated media streaming devices (e.g., the Roku® set-top box), or any other technically feasible computing platform that has network connectivity and is capable of presenting content, such as text, images, video, or audio content, to a user.

Each content server 110 may include a web server, database, and server application 217 configured to communicate with the control server 120 to determine the location and availability of various files that are tracked and managed by the control server 120. Each content server 110 may further communicate with a fill source 130 and one or more other content servers 110 to “fill” each content server 110 with copies of various files. Additionally, content servers 110 may respond to requests for files received from endpoint devices 115. The files may then be distributed from the content server 110 or via a broader content distribution network. In some embodiments, the content servers 110 enable users to authenticate (e.g., using a username and password) to access files stored on the content servers 110. Although only a single control server 120 is shown in FIG. 1, in various embodiments, multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed to fill the content servers 110. Although only a single fill source 130 is shown in FIG. 1, in various embodiments, multiple fill sources 130 may be implemented to service requests for files. Furthermore, as is well understood, any cloud-based services can be included in the architecture of FIG. 1 beyond fill source 130 to the extent desired or necessary.

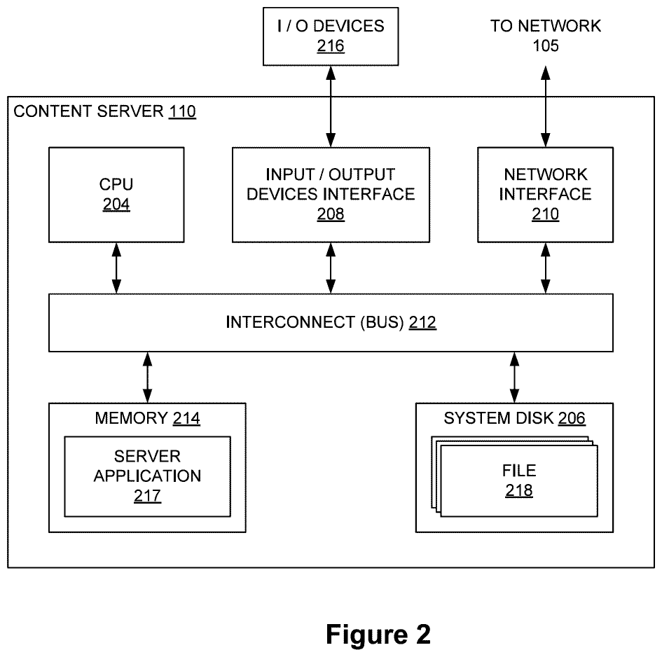

FIG. 2 is a block diagram of a content server 110 that may be implemented in conjunction with the network infrastructure 100 of FIG. 1, according to various embodiments of the present invention. As shown, the content server 110 includes, without limitation, a central processing unit (CPU) 204, a system disk 206, an input/output (I/O) devices interface 208, a network interface 210, an interconnect 212, and a system memory 214.

The CPU 204 is configured to retrieve and execute programming instructions, such as server application 217, stored in the system memory 214. Similarly, the CPU 204 is configured to store application data (e.g., software libraries) and retrieve application data from the system memory 214. The interconnect 212 is configured to facilitate transmission of data, such as programming instructions and application data, between the CPU 204, the system disk 206, I/O devices interface 208, the network interface 210, and the system memory 214. The I/O devices interface 208 is configured to receive input data from I/O devices 216 and transmit the input data to the CPU 204 via the interconnect 212. For example, I/O devices 216 may include one or more buttons, a keyboard, a mouse, and/or other input devices. The I/O devices interface 208 is further configured to receive output data from the CPU 204 via the interconnect 212 and transmit the output data to the I/O devices 216.

The system disk 206 may include one or more hard disk drives, solid-state storage devices, or similar storage devices. The system disk 206 is configured to store non-volatile data such as files 218 (e.g., audio files, video files, subtitles, application files, software libraries, etc.). The files 218 can then be retrieved by one or more endpoint devices 115 via the network 105. In some embodiments, the network interface 210 is configured to operate in compliance with the Ethernet standard.

The system memory 214 includes a server application 217 configured to service requests for files 218 received from endpoint device 115 and other content servers 110. When the server application 217 receives a request for a file 218, the server application 217 retrieves the corresponding file 218 from the system disk 206 and transmits the file 218 to an endpoint device 115 or a content server 110 via the network 105.

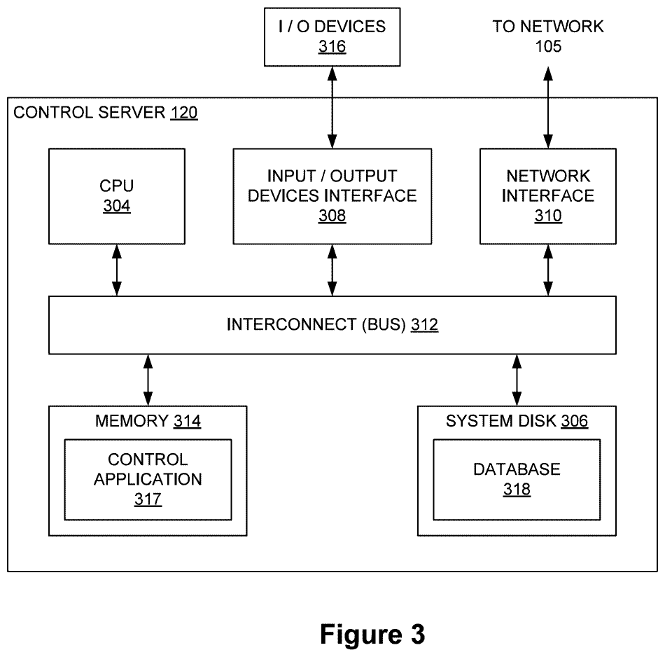

FIG. 3 is a block diagram of a control server 120 that may be implemented in conjunction with the network infrastructure 100 of FIG. 1, according to various embodiments of the present invention. As shown, the control server 120 includes, without limitation, a central processing unit (CPU) 304, a system disk 306, an input/output (I/O) devices interface 308, a network interface 310, an interconnect 312, and a system memory 314.

The CPU 304 is configured to retrieve and execute programming instructions, such as control application 317, stored in the system memory 314. Similarly, the CPU 304 is configured to store application data (e.g., software libraries) and retrieve application data from the system memory 314 and a database 318 stored in the system disk 306. The interconnect 312 is configured to facilitate transmission of data between the CPU 304, the system disk 306, I/O devices interface 308, the network interface 310, and the system memory 314. The I/O devices interface 308 is configured to transmit input data and output data between the I/O devices 316 and the CPU 304 via the interconnect 312. The system disk 306 may include one or more hard disk drives, solid-state storage devices, and the like. The system disk 306 is configured to store a database 318 of information associated with the content servers 110, the fill source(s) 130, and the files 218.

The system memory 314 includes a control application 317 configured to access information stored in the database 318 and process the information to determine the manner in which specific files 218 will be replicated across content servers 110 included in the network infrastructure 100. The control application 317 may further be configured to receive and analyze performance characteristics associated with one or more of the content servers 110 and/or endpoint devices 115.

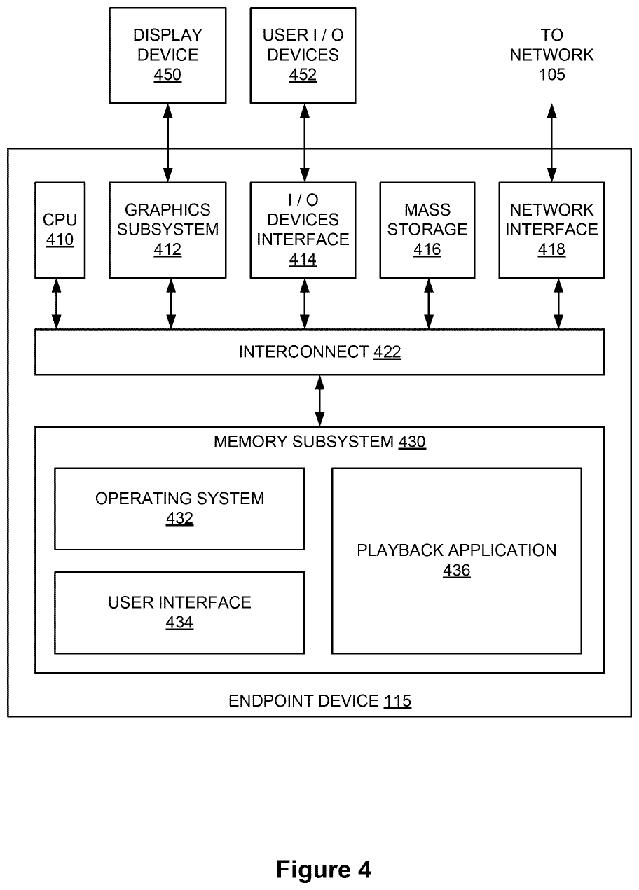

FIG. 4 is a block diagram of an endpoint device 115 that may be implemented in conjunction with the network infrastructure 100 of FIG. 1, according to various embodiments of the present invention. As shown, the endpoint device 115 may include, without limitation, a CPU 410, a graphics subsystem 412, an I/O device interface 414, a mass storage unit 416, a network interface 418, an interconnect 422, and a memory subsystem 430.

In some embodiments, the CPU 410 is configured to retrieve and execute programming instructions stored in the memory subsystem 430. Similarly, the CPU 410 is configured to store and retrieve application data (e.g., software libraries) residing in the memory subsystem 430. The interconnect 422 is configured to facilitate the transmission of data, such as programming instructions and application data, between the CPU 410, graphics subsystem 412, I/O devices interface 414, mass storage unit 416, network interface 418, and memory subsystem 430.

In some embodiments, the graphics subsystem 412 is configured to generate frames of video data and transmit the frames of video data to display device 450. In some embodiments, the graphics subsystem 412 may be integrated into an integrated circuit, along with the CPU 410. The display device 450 may comprise any technically feasible means for generating an image for display. For example, the display device 450 may be fabricated using liquid crystal display (LCD) technology, cathode-ray technology, and light-emitting diode (LED) display technology. An input/output (I/O) device interface 414 is configured to receive input data from user I/O devices 452 and transmit the input data to the CPU 410 via the interconnect 422. For example, user I/O devices 452 may comprise one or more buttons, a keyboard, and a mouse or other pointing device. The I/O device interface 414 also includes an audio output unit configured to generate an electrical audio output signal. User I/O devices 452 include a speaker configured to generate an acoustic output in response to the electrical audio output signal. In alternative embodiments, the display device 450 may include the speaker. A television is an example of a device known in the art that can display video frames and generate an acoustic output.

A mass storage unit 416, such as a hard disk drive or flash memory storage drive, is configured to store non-volatile data. A network interface 418 is configured to transmit and receive packets of data via the network 105. In some embodiments, the network interface 418 is configured to communicate using the well-known Ethernet standard. The network interface 418 is coupled to the CPU 410 via the interconnect 422.

In some embodiments, the memory subsystem 430 includes programming instructions and application data that comprise an operating system 432, a user interface 434, and a playback application 436. The operating system 432 performs system management functions such as managing hardware devices including the network interface 418, mass storage unit 416, I/O device interface 414, and graphics subsystem 412. The operating system 432 also provides process and memory management models for the user interface 434 and the playback application 436. The user interface 434, such as a window and object metaphor, provides a mechanism for user interaction with endpoint device 108. Persons skilled in the art will recognize the various operating systems and user interfaces that are well-known in the art and suitable for incorporation into the endpoint device 108.

In some embodiments, the playback application 436 is configured to request and receive content from the content server 110 via the network interface 418. Furthermore, the playback application 436 is configured to interpret the content and present the content via display device 450 and/or user I/O devices 452.

### Generating Video/Audio Feature Data Based on Advertisement Creative Input

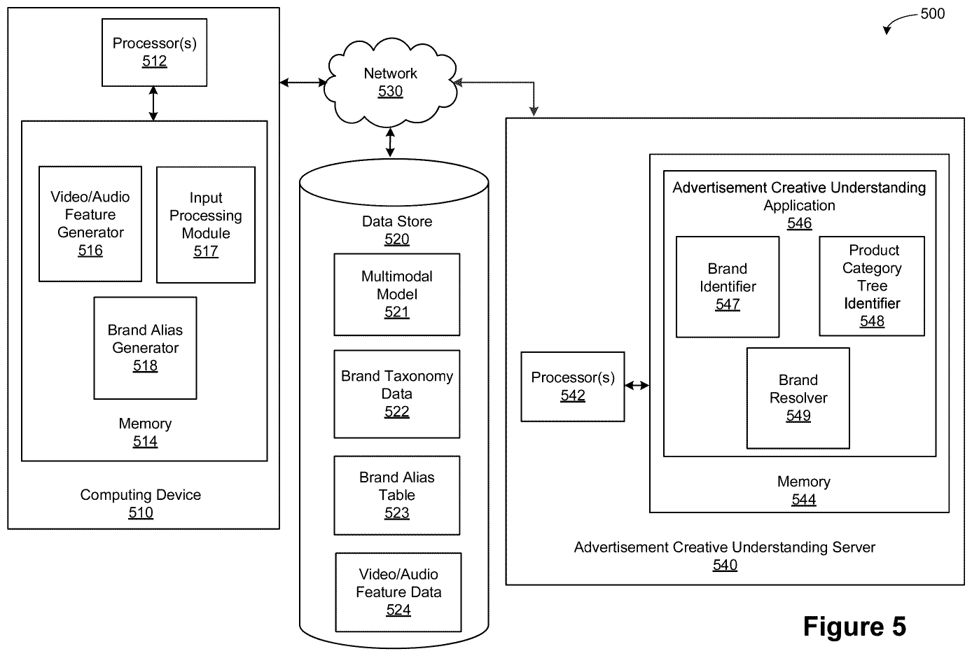

FIG. 5 is a block diagram of a computer-based system 500 according to various embodiments. As shown, computer-based system 500 includes, without limitation, computing device 510, and advertisement creative understanding server 540, a data store 520, and a network 530. Computing device 510 includes, without limitation, one or more processors 512 and memory 514. Memory 514 includes, without limitation, a video/audio feature generator 516 and an input processing module 517. Data store 520 includes, without limitation, a multimodal model 521, brand taxonomy data 522, a brand alias table 523, and video/audio feature data 524. advertisement creative understanding server 540 includes, without limitation, one or more processors 542 and memory 544. Memory 544 includes, without limitation, a brand identifier 547, a product category tree identifier 548, and a brand resolver 549. Although the embodiments of FIG. 5 are described in the context of advertisement creative understanding systems, it is understood that the disclosed techniques are also applicable to other areas of machine learning, such as e-commerce catalog classification, social media content understanding, automated content moderation, digital asset management systems, natural language processing pipelines, and/or the like.

Computing device 510 shown herein is for illustrative purposes only, and variations and modifications in the design and arrangement of computing device 510, without departing from the scope of the present disclosure. For example, the number of processors 512, the number of and/or type of memories 514, and/or the number of applications and/or data stored in memory 514 can be modified as desired. In some embodiments, any combination of processor(s) 512 and/or memory 514 can be included in and/or replaced with any type of virtual computing system, distributed computing system, and/or cloud computing environment, such as a public, private, or a hybrid cloud system.

Each of processor(s) 512 can be any suitable processor, such as a CPU, a GPU, an ASIC, an FPGA, a DSP, a multicore processor, and/or any other type of processing unit, or a combination of two or more of a same type and/or different types of processing units, such as a SoC, or a CPU configured to operate in conjunction with a GPU. In general, processors 512 can be any technically feasible hardware unit capable of processing data and/or executing software applications. During operation, processor(s) 512 can receive user input from input devices (not shown), such as a keyboard or a mouse.

Memory 514 of computing device 510 stores content, such as software applications and data, for use by processor(s) 512. As shown, memory 514 includes, without limitation, video/audio feature generator 516 and input processing module 517. Memory 514 can be any type of memory capable of storing data and software applications, such as a random-access memory (RAM), a read-only memory (ROM), an erasable programmable read-only memory (EPROM or Flash ROM), or any suitable combination of the foregoing. In some embodiments, additional storage (not shown) can supplement or replace memory 514. The storage can include any number and type of external memories that are accessible to processor(s) 512. For example, and without limitation, the storage can include a Secure Digital Card, an external Flash memory, a portable CD-ROM, an optical storage device, a magnetic storage device, and/or any suitable combination of the foregoing.

Input processing module 517 is stored in memory 514 and is executed by processor(s) 512. Input processing module 517 is an application that processes an advertisement creative input received via one or more I/O devices and generates advertisement video data and advertisement audio data. In some embodiments, input processing module 517 extracts raw advertisement video data and raw advertisement audio data from the advertisement creative input by demultiplexing the advertisement creative input media stream or by separating embedded video and audio tracks. For example, input processing module 517 can utilize media processing tools or libraries, such as FFmpeg, GStreamer, and/or the like, to extract video frames and audio waveforms from a media file container, such as MP4, MOV, MKV, and/or the like. In some embodiments, the advertisement creative input includes still image data, such as banner ads, thumbnails, and/or the like. Input processing module 517 extracts the one or more still images included in the advertisement creative input and includes the one or more still images in the advertisement video data.

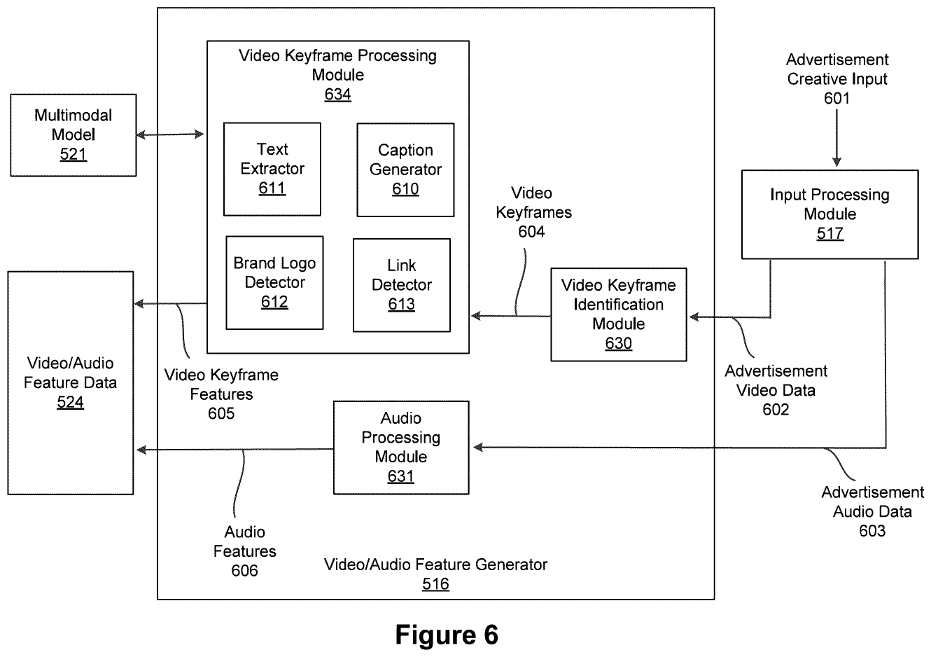

Video/audio feature generator 516 is stored in memory 514 and is executed by processor(s) 512. Video/audio feature generator 516 is an application that uses the multimodal model 521 to process the advertisement video data and the advertisement audio data and generate video/audio feature data 524. In some embodiments, video/audio feature generator 516 includes, without limitation, a video keyframe identification module, a video keyframe processing module, and an audio processing module. The video keyframe identification module processes the advertisement video data and generates one or more video keyframes. The video keyframe processing module uses the multimodal model to process the video keyframes and generate one or more keyframe features, such as captions, links, texts, and brand logos. The audio processing module processes the advertisement audio data and generates one or more audio features, such as audio transcript and audio language. Video/audio feature generator 516 stores the video keyframe features and the audio features in video/audio feature data 524, which is stored in datastore 520. Video/audio feature generator 516 is described in greater detail in conjunction with FIGS. 6, 7, 10 and 11.

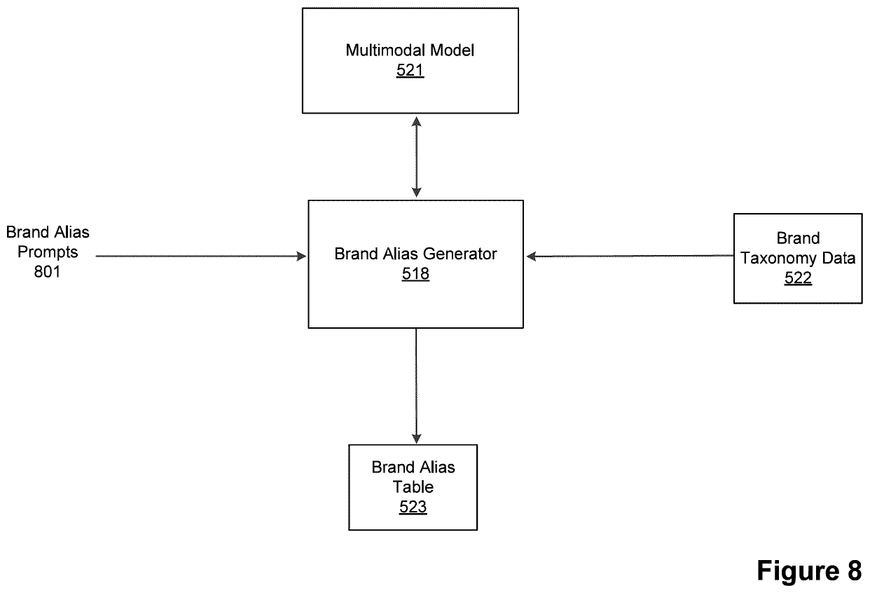

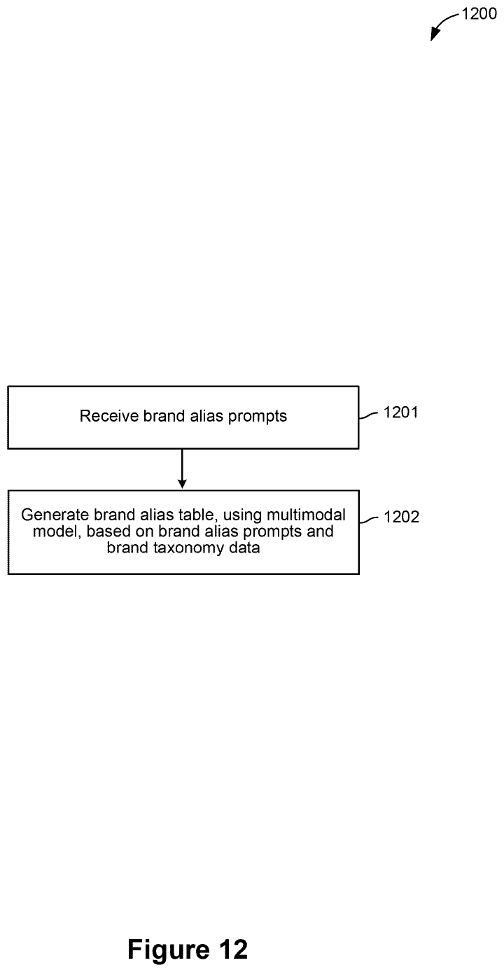

Brand alias generator 518 is stored in memory 514 and is executed by processor(s) 512. Brand alias generator 518 is an application that uses multimodal model 521 to process one or more brand alias prompts and brand taxonomy data 522 and generate brand alias table 523. Brand alias generator 518 is described in greater detail in conjunction with FIGS. 8 and 12.

Data store 520 can include any storage device or devices, such as fixed disc drive(s), flash drive(s), optical storage, network-attached storage (NAS), and/or a storage area-network (SAN). Although shown as accessible over network 530, in some embodiments computing device 510 can include data store 520. As shown, data store 520 is storing multimodal model 521, brand taxonomy data 522, brand alias table 523, and video/audio feature data 524.

Multimodal model 521 is a machine learning model that interacts with video/audio feature generator 516 to process the advertisement video data and the advertisement audio data and generate video/audio feature data 524, processes one or more brand alias prompts and brand taxonomy data 522 to generate brand alias table 523, and interacts with advertisement creative understanding application 546 to process video/audio feature data 524, brand taxonomy data 522, and brand alias table 523 and generate a product category tree, one or more resolved brands, and optionally a chain-of-thought (CoT). In some embodiments, the product category tree, the one or more resolved brands, and the CoT can be used to support at least one of advertisement targeting, frequency capping, brand separation, or compliance checking. In some embodiments, multimodal model 521 includes a large language model (LLM) that has been pretrained on large-scale text corpora, such as internet-scale datasets, books, structured documents, and/or the like. In some embodiments, the LLM is configured to process textual components of the video/audio feature data 524 (e.g., text, audio transcripts, captions) and perform prompt-based reasoning to identify brands, resolve brand entities, and classify product categories based on brand taxonomy data 522. In some other embodiments, multimodal model 521 includes a vision-language model (VLM) that has been pretrained on large-scale image-text pairs, enabling the VLM to jointly process both visual and textual inputs. In some embodiments, the VLM is configured to process combined inputs such as keyframe images and associated textual data, and generate outputs including brand identifications, resolved brand entities, product category classifications, and CoT reasoning. In some embodiments, multimodal model 521 processes one or more brand alias prompts and brand taxonomy data 522 to generate brand alias table 523. The brand taxonomy data 522 includes a structured collection of standardized brand names and associated identifiers. In some embodiments, each entry in brand taxonomy data 522 includes metadata, such as a canonical brand name, an internal brand identifier, a parent brand name or identifier where applicable, and a category affiliation corresponding to primary market or product segment of the brand. For example, brand taxonomy data 522 can include an entry for “Coca-Kola Company” as the canonical brand name, with an associated brand identifier, parent brand relationship to “The Coca-Kola Company,” and an affiliation with the “Beverages->Soft Drinks” category. Similarly, brand taxonomy data 522 can include an entry for “Hike,” linked to the parent brand “Hike, Inc.” and categorized under “Apparel->Footwear->Sports Shoes.” Brand alias table 523 stores one or more aliases associated with each standardized brand name included in brand taxonomy data 522. For example, for the brand “Coca-Kola Company,” brand alias table 523 can include aliases such as “Coca-Kola,” “Koke,” “Coca Kola,” and “Koke Zero,” while for “Ultra Airlines,” brand alias table 523 can include aliases such as “Ultra,” “UL,” and “Ult Air.”

Network 530 can be a wide area network (WAN), such as the Internet, a local area network (LAN), a cellular network, and/or any other suitable network. Computing devices 510 and 540 and data store 520 are in communication over network 530. For example, network 530 can include any technically feasible network hardware suitable for allowing two or more computing devices to communicate with each other and/or to access distributed or remote data storage devices, such as data store 520.

Advertisement creative understanding server 540 shown herein is for illustrative purposes only, and variations and modifications in the design and arrangement of advertisement creative understanding server 540, without departing from the scope of the present disclosure. For example, the number of processors 542, the number of and/or type of memories 544, and/or the number of applications and/or data stored in memory 544 can be modified as desired. In some embodiments, any combination of processor(s) 542 and/or memory 544 can be included in and/or replaced with any type of virtual computing system, distributed computing system, and/or cloud computing environment, such as a public, private, or a hybrid cloud system.

Each of processor(s) 542 can be any suitable processor, such as a CPU, a GPU, an ASIC, an FPGA, a DSP, a multicore processor, and/or any other type of processing unit, or a combination of two or more of a same type and/or different types of processing units, such as a SoC, or a CPU configured to operate in conjunction with a GPU. In general, processors 542 can be any technically feasible hardware unit capable of processing data and/or executing software applications. During operation, processor(s) 542 can receive user input from input devices (not shown), such as a keyboard or a mouse.

Memory 544 of computing device 540 stores content, such as software applications and data, for use by processor(s) 542. As shown, memory 544 includes, without limitation, brand identifier 547, product category tree identifier 548, and brand resolver 549. Memory 544 can be any type of memory capable of storing data and software applications, such as a RAM, a ROM, an EPROM or a Flash ROM, or any suitable combination of the foregoing. In some embodiments, additional storage (not shown) can supplement or replace memory 544. The storage can include any number and type of external memories that are accessible to processor(s) 542. For example, and without limitation, the storage can include a Secure Digital Card, an external Flash memory, a portable CD-ROM, an optical storage device, a magnetic storage device, and/or any suitable combination of the foregoing.

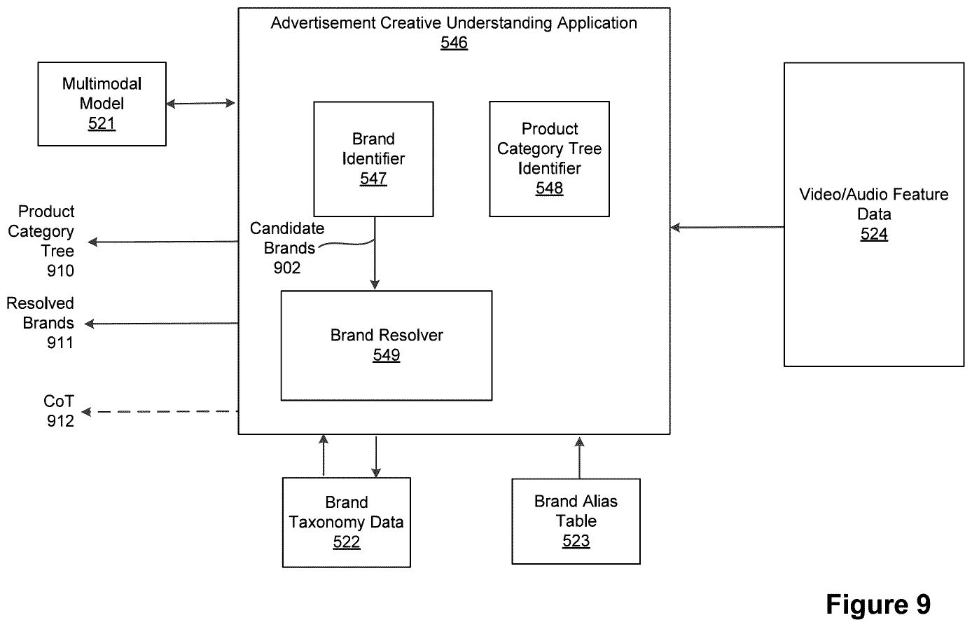

As shown, advertisement creative understanding application 546 is stored in memory 544 and executes on processor(s) 542. advertisement creative understanding application 546 uses multimodal model 521 to process video/audio feature data 524, brand taxonomy data 522, and brand alias table 523 and generate the product category tree, the resolved brands, and optionally the CoT. Advertisement creative understanding application 546 includes, without limitation, brand identifier 547, product category tree identifier 548, and brand resolver 549. Brand identifier 547 uses multimodal model 521 to process the video/audio feature data 524 and generate one or more candidate brands. Brand resolver 549 uses multimodal model 521 to process the candidate brands, brand taxonomy data 522, and brand alias table 523 to generate resolved brands. In some embodiments, brand resolver 549 also adds one or more brand names to brand taxonomy data 522 when the one or more candidate brands are not included in brand taxonomy data 522 and brand alias table 523, and are not found by multimodal model 521 as a standardized brand name. Product category tree identifier 547 uses multimodal model 521 to process video/audio feature data 524 and brand taxonomy data 522 and generate the product category tree. advertisement creative understanding application 546 is described in greater detail in conjunction with FIGS. 9 and 13-15.

FIG. 6 is a more detailed illustration of video/audio feature generator 516, according to various embodiments. As shown, video/audio feature generator 516 includes, without limitation, video keyframe identification module 630, video keyframe processing module 634, and audio processing module 631. Video keyframe processing module 634 includes, without limitation, caption generator 610, text extractor 611, brand logo detector 612, and link detector 613. In operation, input processing module 517 processes advertisement creative input 601 and generates advertisement video data 602 and advertisement audio data 603. Video keyframe identification module 630 processes advertisement video data 602 and generates video keyframes 604. Audio processing module 631 processes advertisement audio data 603 and generates audio features 606. Video keyframe processing module 634 uses multimodal model 521 to process video keyframes 604 and generate video keyframe features 605. Video audio feature generator 516 stores audio features 606 and video keyframe features 605 in video/audio feature data 524.

Input processing module 517 processes an advertisement creative input 601 received via one or more I/O devices and generates advertisement video data and advertisement audio data. In some embodiments, input processing module 517 extracts raw advertisement video data and raw advertisement audio data from the advertisement creative input 601 by demultiplexing the advertisement creative input 601 media stream or by separating embedded video and audio tracks. For example, input processing module 517 can utilize media processing tools or libraries, such as FFmpeg, GStreamer, and/or the like, to extract video frames and audio waveforms from a media file container, such as MP4, MOV, MKV, and/or the like. In some embodiments, advertisement creative input 601 includes still image data, such as banner ads, thumbnails, and/or the like. Input processing module 517 extracts the one or more still images included in the advertisement creative input 601 and includes the one or more still images in the advertisement video data. In some embodiments, advertisement creative input 601 is received in various forms, including but not limited to as a media file uploaded through an interface, as a data stream, or as a reference link, such as a Uniform Resource Locator (URL) or content delivery network (CDN) link, pointing to a location from which advertisement creative input 601 can be retrieved.

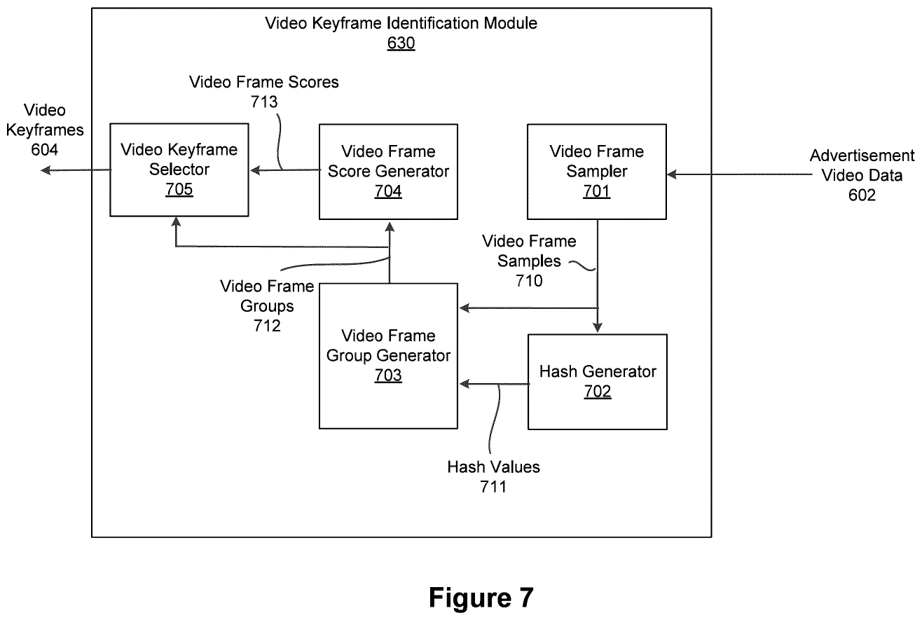

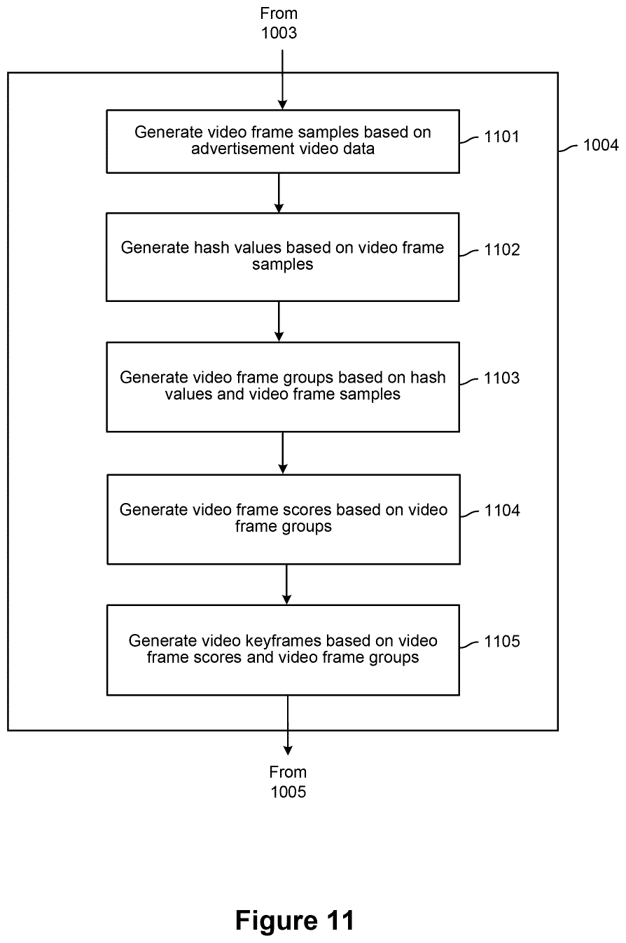

Video keyframe identification module 630 is an application that processes advertisement video data 602 and generates video keyframes 604. In some embodiments, video keyframe identification module 630 includes, without limitation, a video frame sampler, a hash generator, a video frame group generator, a video frame score generator, and a video keyframe selector. The video frame sampler processes advertisement video data 602 and generates one or more video frame samples. The hash generator processes the video frame samples and generates one or more hash values. The video frame group generator processes the video frame samples and the hash values and generates one or more video frame groups. The video frame score generator processes the video frame groups and generates one or more video frame scores. The video keyframe selector processes the video frame scores and generates one or more video keyframes 604. In some embodiments, video keyframes 604 include a reduced set of video frames selected to include visually and semantically significant moments within the advertisement video data 602. For example, video keyframes 604 can include video frames where brand logos are prominently displayed, product packaging appears in focus, key text such as promotional offers or disclaimers is shown, or where the overall visual composition is informative for understanding the advertisement content. Video keyframe identification module 630 is described in greater detail in conjunction with FIGS. 7 and 11.

Audio processing module 631 is an application that processes advertisement audio data 603 and generates audio features 606. In some embodiments, audio processing module 631 extracts an audio transcript from advertisement audio data 603 using an automatic speech recognition (ASR) model, such as an LLM-based ASR (e.g., faster-whisper model) or a conventional ASR system. The audio transcript includes the spoken content of advertisement audio data 603 in text form, including product names, brand mentions, promotional language, disclaimers, and other relevant information. For example, when audio data 603 promotes a beverage, the audio transcript can include phrases such as “Try the new Coca-Kola Zero Sugar,” which can be used for brand identification and product category classification. In some embodiments, audio processing module 631 also detects the audio language of advertisement audio data 603 using language detection models, language classification modules, and/or the like, integrated with an ASR pipeline. The detected audio language is encoded as an audio language indicator and included in audio features 606. For example, when the spoken content of advertisement audio data 603 is in Spanish, the audio language indicator can specify “es” for Spanish; when in English, the audio language indicator can specify “en.” The audio language can be used to support compliance checks, regional targeting, or multi-language analysis workflows. In some embodiments, audio processing module 631 extracts additional features from advertisement audio data 603, such as speaker diarization (e.g., identifying different speakers), tone or sentiment indicators, timing data that associates specific transcript segments with corresponding time intervals in the advertisement audio data 603, and/or the like.

Video keyframe processing module 634 is an application that uses multimodal model 521 to process video keyframes 604 and generate video keyframe features 605. Video keyframe processing module 634 includes caption generator 610, text extractor 611, brand logo detector 612, and link detector 613. Caption generator 610 uses multimodal model 521 to process video keyframes 604 and generate one or more video keyframe captions. In some embodiments, caption generator 610 generates a natural language description of the visual content of each video keyframe 604, using a VLM or a LLM included n multimodal model 521 configured to process image data included in video keyframes 604 and generate a textual output included in video keyframe captions. The generated video keyframe captions include key visual elements present in the video keyframes 604, such as products, brand logos, promotional text, scenes, or objects. For example, for a video keyframe 604 showing a soda can with a prominent Coca-Kola logo, caption generator 610 can generate a caption such as “A can of Coca-Kola with a red and white logo placed on a table.” For a video keyframe 604 showing a clothing brand logo on a sneaker, caption generator 610 can generate a video keyframe caption such as “Hike Air running shoe with visible swoosh logo.” Text extractor 611 processes video keyframes 604 and generates video keyframe texts. In some embodiments, text extractor 611 applies optical character recognition (OCR) techniques to extract textual content present within each video keyframe 604. The extracted text included in the video keyframe texts includes brand names, product names, promotional slogans, legal disclaimers, pricing information, or any other text visible in video keyframes 604. For example, when a video keyframe 604 displays an on-screen message such as “Limited Time Offer—50% Off Hike Footwear,” text extractor 611 can generate a corresponding video keyframe text output containing the phrase “Limited Time Offer—50% Off Hike Footwear.” Similarly, when a video keyframe 604 includes packaging with a brand label such as “Coca-Kola Zero Sugar,” the extracted text can include “Coca-Kola Zero Sugar.” Brand logo detector 612 processes video keyframes 604 and generates video keyframe brand logos. In some embodiments, brand logo detector 612 applies one or more computer vision models, such as a convolutional neural network (CNN), a vision transformer, or a logo detection model trained on labeled logo datasets, to detect and recognize brand logos present within each video keyframe 604. The detected brand logos included in video keyframe brand logos include visual representations of brand names, symbols, or trademarks that appear on product packaging, clothing, signage, or other elements within the video keyframes 604. For example, when a video keyframe 604 shows a beverage can displaying the Coca-Kola logo, brand logo detector 612 can generate a corresponding video keyframe brand logo output indicating the presence of the “Coca-Kola” logo, along with additional metadata such as the logo bounding box location and confidence score. Similarly, when a video keyframe 604 displays a Hike swoosh on a sneaker, brand logo detector 612 can generate a video keyframe brand logo output indicating the presence of the “Hike” logo. Link detector 613 processes video keyframes 604 and generates one or more video keyframe links. In some embodiments, link detector 613 applies OCR, pattern matching, and natural language processing techniques to identify textual content within video keyframes 604 that includes links or references to external resources. The links can include URLs, quick response (QR) codes, or other types of machine-readable references embedded within the visual content of video keyframes 604. For example, when a video keyframe 604 displays a text string such as “www.example.com,” the link detector 613 can extract and generate a corresponding video keyframe link for “www.example.com.” Similarly, when a video keyframe 604 includes a QR code, link detector 613 can decode the QR code and generate a video keyframe link corresponding to the encoded URL or action. In some embodiments, video keyframe processing module 634 aggregates the video keyframe captions, the video keyframe texts, the video keyframe brand logos, and the video keyframe links into video keyframe features 605.

### Generating Video Keyframes Based on Advertisement Creative Data

FIG. 7 is a more detailed illustration of keyframe identification module 630, according to various embodiments. As shown, video keyframe identification module 630 includes, without limitation, video frame sampler 701, hash generator 702, video frame group generator 703, video frame score generator 704, and video keyframe selector 705. In operation, video frame sampler 701 processes advertisement video data 602 and generates one or more video frame samples 710. Hash generator 702 processes video frame samples 710 and generates one or more hash values 711. Video frame group generator 703 processes video frame samples 710 and hash values 711 and generates one or more video frame groups 712. Video frame score generator 704 processes video frame groups 712 and generates one or more video frame scores 713. Video keyframe selector 705 processes video frame scores 713 and generates one or more video keyframes 604.

Video frame sampler 701 is an application that processes advertisement video data 602 and generates video frame samples 710. In some embodiments, video frame sampler 701 extracts video frame samples 710 from advertisement video data 602 at a specified sampling rate or based on scene change detection. For example, video frame sampler 701 can extract video frames at fixed intervals (e.g., one frame per second) or dynamically adjust the sampling rate based on visual content variation within the video stream included in advertisement video data 602. In some embodiments, video frame sampler 701 detects scene transitions, such as changes in background, lighting, or object composition, and prioritizes the extraction of video frames corresponding to the transitions.

Hash generator 702 is an application that processes video frame samples 710 and generates hash values 711. In some embodiments, hash generator 702 applies a perceptual hashing (pHash) algorithm to each video frame sample 710 to generate a corresponding hash value 711 that captures the overall visual appearance of the video frame included in video frame samples 710 in a compact and comparison-friendly form. Perceptual hashes included in hash values 711 encode visual information, such as color distribution, edge patterns, spatial structure, and general image content in a manner that allows visually similar video frames to be assigned similar hash values 711, even in the presence of minor variations such as compression artifacts or scaling. For example, hash generator 702 can apply a perceptual hash algorithm such as average hash (aHash) algorithm, difference hash (dHash) algorithm, and/or the like, to generate hash values 711 for video frame samples 710. In some embodiments, hash generator 702 uses a wavelet hash algorithm, which applies a wavelet transform to the video frame sample 710 to generate a hash value 711 that is robust to variations in scale, compression, and minor visual distortions.

Video keyframe group generator 703 is an application that processes video frame samples 710 and hash values 711 and generates video frame groups 712. In some embodiments, video keyframe group generator 703 compares hash values 711 associated with video frame samples 710 to identify and group visually similar video frames. In some embodiments, video keyframe group generator 703 applies a similarity threshold to the hash values 711 to determine whether two video frames included in video frame samples 710 should be assigned to the same video frame group 712. For example, video keyframe group generator 703 can compute the Hamming distance between perceptual hash values included in hash values 711 and group together video frames included in video frame samples 710 whose hash values 711 fall within a predefined distance threshold. In some embodiments, video frame group generator 703 computes distance metrics, such as cosine similarity distance, Euclidean distance, and/or the like, to form groups of visually similar frames. In some embodiments, video frame group generator 703 groups together consecutive video frame samples 710 that show substantially the same visual content, such as a static product shot, brand logo, text screen, or consistent scene background. For example, when a sequence of video frame samples 710 includes a static shot of a product package or an on-screen promotional message, video keyframe group generator 703 groups the frames into a single video frame group 712.

Video frame score generator 704 is an application that processes video frame groups 712 and generates video frame scores 713. In some embodiments, video frame score generator 704 applies one or more scoring heuristics or machine learning models to assign a relevance score to each video frame included in a video frame group 712. Each video frame score 713 includes the degree to which a given video frame is likely to include semantically significant visual content useful for advertisement creative understanding tasks. In some embodiments, video frame score generator 704 computes scores included in video frame scores 713 based on image characteristics, such as the amount of high-frequency visual detail, the presence of text regions as detected by OCR, logo detections, or other saliency cues. For example, video frame score generator 704 applies a discrete cosine transform (DCT) to measure the frequency content of a video frame included in video frame groups 712 and assign higher scores to the video frames with greater visual detail, which are more likely to include relevant information, such as product packaging or on-screen text. In some embodiments, video frame score generator 704 computes image entropy scores, which measure the information density and complexity of the visual content within a video frame included in video frame groups 712. Higher entropy scores typically indicate the presence of diverse visual patterns, edges, or text, whereas low entropy scores indicate blank screens, static backgrounds, or low-information frames. In some embodiments, video frame score generator 704 combines entropy scores with other scoring factors, such as high-frequency content, OCR token density, and logo detection confidence, to generate a composite video frame score 713. For example, a video frame containing a clear brand logo and a dense text overlay can receive a high composite score, while a frame containing a plain background or scene transition can receive a low composite score.

Video keyframe selector 705 processes video frame scores 713 and video frame groups 712 and generates video keyframes 604. In some embodiments, video keyframe selector 705 selects one or more representative video frames included in each video frame group 712 based on the corresponding video frame scores 713. In some embodiments, video keyframe selector 705 selects the video frame within each video frame group 712 that has the highest video frame score 713. Video keyframes 604 include video frames that include product packaging, brand logos, promotional text, legal disclaimers, calls-to-action, or other visually salient content useful for brand identification and product category tree classification. In some embodiments, video keyframe selector 705 applies one or more selection criteria to permit temporal diversity and avoid over-representation of static scenes. For example, video keyframe selector 705 can limit the number of selected video keyframes 604 from consecutive time windows or can enforce a minimum temporal distance between selected video keyframes 604. In some embodiments, video keyframe selector 705 prioritizes video frame groups 712 with high overall scores or greater visual complexity to ensure that video keyframes 604 provide a broad and informative representation of the advertisement creative input 601.

### Generating Brand Alias Table Based on Brand Alias Prompts and Brand Taxonomy Data

FIG. 8 is a more detailed illustration of brand alias generator 518, according to various embodiments. In operation, brand alias generator 518 uses multimodal model 521 to process one or more brand alias prompts 801 and brand taxonomy data 522 and generate brand alias table 523.

Brand alias generator 518 employs multimodal model 521 to process one or more brand alias prompts 801 and brand taxonomy data 522 and generate brand alias table 523. In some embodiments, brand alias generator 518 utilizes the multimodal model 521 to generate a list of alternate names, abbreviations, colloquial references, and other variations for each standardized brand name included in brand taxonomy data 522. In some embodiments, brand alias prompts 801 are received or generated through either automated workflows or user-defined configurations. In some embodiments, brand alias prompts 801 are automatically generated based on templates that include the standardized brand name and relevant metadata, such as the parent company of the brand or product category. In some embodiments, users or administrators configure or edit brand alias prompts 801 to refine instructions given to multimodal model 521 for generating aliases for specific brands included in brand taxonomy data 522. In some embodiments, brand alias prompts 801 are generated to instruct multimodal model 521 to return likely references or appearances of each brand included in brand taxonomy data 522 in natural language, visual text, or spoken audio within advertisement creatives. For example, for the standardized brand name “Ultra Airlines,” brand alias generator 518 can prompt multimodal model 521 to return aliases such as “Ultra,” “Ult,” and “Ult Air.” Similarly, for the standardized brand name “Coca-Kola Company,” brand alias generator 518 may generate aliases such as “Coca-Kola,” “Coke,” “Coca Kola,” and “Coke Zero.”

### Generating Resolved Brands and Product Category Trees Based on Video/Audio Feature Data

FIG. 9 is a more detailed illustration of the advertisement creative understanding application 546, according to various embodiments. As shown, advertisement creative understanding application 546 includes, without limitation, brand identifier 547, product category tree identifier 548, and brand resolver 549. In operation, brand identifier 547 uses the multimodal model 521 to process the video/audio feature data 524 and generate one or more candidate brands 901. Brand resolver 549 uses multimodal model 521 to process candidate brands 901, brand taxonomy data 522, and brand alias table 523 to generate resolved brands 911. In some embodiments, brand resolver 549 also adds one or more brand names to brand taxonomy data 522 when one or more candidate brands 902 are not included in brand taxonomy data 522 and brand alias table 523, and are not found by multimodal model 521 as a standardized brand name. Product category tree identifier 548 uses multimodal model 521 to process video/audio feature data 524 and brand taxonomy data 522 to generate product category tree 910 and optionally CoT 912.

Brand identifier 547 is an application that uses multimodal model 521 to process video/audio feature data 524 and generate candidate brands 902. In some embodiments, brand identifier 547 uses multimodal model 521 to analyze a combination of textual and visual features included in video/audio feature data 524, such as audio transcripts, audio language indicators, video keyframe captions, video keyframe texts, video keyframe brand logos, and video keyframe links. In some embodiments, brand identifier 547 applies prompt-based reasoning using multimodal model 521 to infer one or more candidate brands 902 that are referenced, promoted, or visually shown in advertisement creative input 601. For example, brand identifier 547 can identify a candidate brand 902 “Coca-Kola” based on references detected in the audio transcript, OCR-extracted text such as “Coca-Kola Zero Sugar,” and detected brand logos present in video keyframes 604. In another example, brand identifier 547 can infer candidate brand 902 “Hike” based on a combination of a detected swoosh logo, video caption text describing “Hike Air running shoes,” and spoken mentions of “Hike” in the audio transcript. In some embodiments, brand identifier 547 also generates confidence scores or justifications for each candidate brand 902 to indicate the strength of the supporting evidence.

Brand resolver 549 is an application that uses multimodal model 521 to process candidate brands 902, brand taxonomy data 522, and brand alias table 523 to generate resolved brands 911. In some embodiments, brand resolver 549 applies a multi-stage entity resolution workflow to map each candidate brand 902 to a corresponding standardized brand name in brand taxonomy data 522. The entity resolution process begins by determining whether candidate brand 902 exactly matches a standardized brand name already included in brand taxonomy data 522. Whenever such a match is found, brand resolver 549 generates a resolved brand 911 corresponding to the matched standardized brand. Whenever candidate brand 902 is not found in brand taxonomy data 522, brand resolver 549 next determines whether candidate brand 902 matches any known alias stored in brand alias table 523. In some embodiments, brand alias table 523 includes a list of alternate names and forms of reference for each standardized brand, generated through prior use of brand alias prompts with multimodal model 521. Whenever candidate brand 902 matches an alias included in brand alias table 523, brand resolver 549 generates resolved brand 911 using the corresponding brand alias. Whenever candidate brand 902 is not matched in either brand taxonomy data 522 or brand alias table 523, brand resolver 549 performs a fallback query using multimodal model 521. In some embodiments, brand resolver 549 constructs a prompt that includes candidate brand 902 and a contextual list of standardized brands from brand taxonomy data 522 and queries multimodal model 521 to determine whether the candidate brand 902 can be semantically mapped to an existing standardized brand. For example, whenever candidate brand 902 is “UA” and is not explicitly listed in brand taxonomy data 522 or brand alias table 523, brand resolver 549 can prompt multimodal model 521 with “UA” and a list of possible brands such as “Up Armour,” “Ultra Airlines,” “Up Armor Gear,” and others. When multimodal model 521 returns “Up Armour” as the correct mapping, brand resolver 549 generates resolved brand 911 corresponding to the standardized brand “Up Armour.” Whenever no standardized brand name can be found using any of the above steps, brand resolver 549 adds candidate brand 902 as a suggested new brand entry to brand taxonomy data 522. In some embodiments, suggested new brands are queued for human review and taxonomy enrichment. For example, when candidate brand 902 is “ZX Beverages,” and neither the brand taxonomy data 522 nor brand alias table 523 contain the brand, and multimodal model 521 is unable to map “ZX Beverages” to an existing standardized brand, brand resolver 549 can add “ZX Beverages” to brand taxonomy data 522 for future resolution and reporting. In some embodiments, resolved brand 911 includes metadata, such as a confidence score and a justification trace generated by multimodal model 521. The justification trace includes the reasoning or contextual signals used to resolve the brand, providing transparency and enabling downstream auditing or human-in-the-loop review.

Product category tree identifier 548 is an application that uses multimodal model 521 to process video/audio feature data 524 and brand taxonomy data 522 to generate product category tree 910 and optionally CoT 912. In some embodiments, product category tree identifier 548 applies a hierarchical classification workflow using multimodal model 521 to generate a structured product category tree 910 for each advertisement creative input 601. The classification process begins by using multimodal model 521 to generate a top-level category for the advertisement creative input 601 based on video/audio feature data 524. In some embodiments, the top-level category is selected from a predefined set of high-level categories, such as “Apparel,” “Consumer Electronics,” “Beverages,” “Financial Services,” or “Automotive.” For example, whenever video/audio feature data 524 includes references to “Hike running shoes,” the top-level category generated can be “Apparel.” Next, product category tree identifier 548 generates a filtered subtree of leaf category nodes based on the selected top-level category, video/audio feature data 524, and brand taxonomy data 522. In some embodiments, the filtered subtree includes the leaf categories that are valid children of the selected top-level category, thereby reducing ambiguity and improving classification accuracy. For example, whenever the top-level category is “Apparel,” the filtered subtree can include leaf categories such as “Footwear,” “Athletic Footwear,” “Outerwear,” and “Sportswear.” Product category tree identifier 548 then uses multimodal model 521 to generate one or more specific leaf category nodes based on the filtered subtree and video/audio feature data 524. For example, when the filtered subtree includes “Athletic Footwear” and the video/audio feature data 524 contains captions such as “Hike Air Zoom Pegasus running shoes,” product category tree identifier 548 can generate the leaf category “Athletic Footwear>Running Shoes.” Based on the selected top-level category and one or more leaf category nodes, product category tree identifier 548 generates product category tree 910. In some embodiments, product category tree 910 includes a structured hierarchy of categories that reflects the content of advertisement creative input 601, permitting accurate reporting and policy enforcement. In some embodiments, product category tree identifier 548 receives a pre-generated filtered subtree of leaf category nodes derived from the brand taxonomy data 522 and based on a previously determined top-level category. The filtered subtree is generated during a preprocessing phase and cached for runtime efficiency. Accordingly, during inference, product category tree identifier 548 bypasses filtered subtree of leaf category nodes generation and proceed directly to generating leaf category nodes using the cached filtered subtree of leaf category nodes. In some embodiments, product category tree identifier 548 optionally generates CoT 912, where multimodal model 521 is used to generate a chain-of-thought reasoning trace explaining the rationale behind the selected categories. For example, CoT 912 can include statements such as “The advertisement promotes Hike running shoes, which belong to the Apparel category, specifically under Footwear and Athletic Footwear>Running Shoes.” In some examples, CoT 912 can be used for explainability, auditing, or human-in-the-loop review. In some embodiments, to further improve the accuracy of product category classification, brand taxonomy data 522 is pre-processed using multimodal model 521 to generate model-friendly versions of category names and category definitions. In some embodiments, one or more category names do not fully capture the scope of the category, potentially leading to confusion for multimodal model 521. For example, the category “Printers” is defined as “Printers, copiers, scanners, and fax machines are office devices that provide essential document management and communication services, including printing, duplicating, digitizing, and transmitting documents, aimed at enhancing productivity and efficiency in both home and professional settings.” The definition includes not only printers but also other office document management devices. To address category names that do not fully capture the scope of the category, a preprocessing step using multimodal model 521 is performed to generate model-friendly category names based on human-curated definitions. For example, the revised category name can be “Printers, Scanners, Copiers, and Other Office Document Management Devices,” which more clearly reflects the scope of the category. In some embodiments, one or more category definitions could confuse multimodal model 521 due to ambiguous or overly descriptive wording. A preprocessing step is performed to revise category definitions into model-friendly, instruction-based formats, using the path of the category in the taxonomy tree and category node name. For example, the category “Independent Living” can be revised to “Independent Senior Living Communities.” The original definition, “Independent living refers to residential communities for seniors who maintain their independence while enjoying access to amenities and services like housekeeping, dining, and recreational activities, fostering a supportive and engaging living environment,” can be rewritten as “If an advertisement features residential communities for seniors that emphasize independence while offering amenities and services such as housekeeping, dining, and recreational activities, please include ‘Independent Senior Living Communities’ as a product category.” In some embodiments, both the model-friendly category names and revised category definitions are generated as one-time preprocessing steps, and the results are persisted in brand taxonomy data 522.

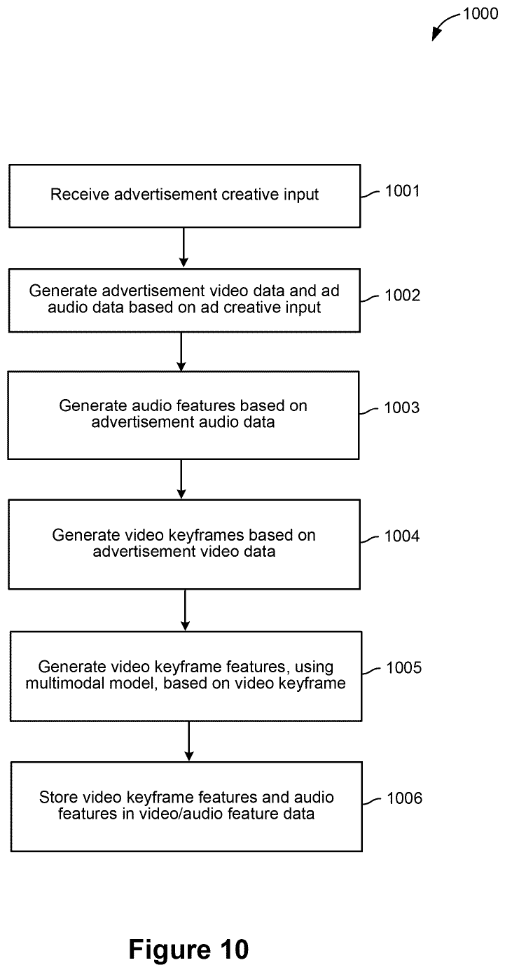

FIG. 10 sets forth a flow diagram of method steps for generating the video/audio feature data 516, according to various embodiments. Although the method steps are described in conjunction with the systems of FIGS. 1-9, persons skilled in the art will understand that any system configured to perform the method steps in any order falls within the scope of the present disclosure.

The method 1000 begins with step 1001, where input processing module 517 receives advertisement creative input 601. In some embodiments, advertisement creative input 601 is received in various forms, including, but not limited to, a media file uploaded through an interface, a data stream, or a reference link, such as a URL or CDN link, pointing to a location from which advertisement creative input 601 can be retrieved.

At step 1002, input processing module 517 generates advertisement video data 602 and advertisement audio data 603 based on advertisement creative input 601. In some embodiments, input processing module 517 extracts raw advertisement video data and raw advertisement audio data from the advertisement creative input 601 by demultiplexing the advertisement creative input media 601 stream or by separating embedded video and audio tracks. For example, input processing module 517 can utilize media processing tools or libraries, such as FFmpeg, GStreamer, and/or the like, to extract video frames and audio waveforms from a media file container, such as MP4, MOV, MKV, and/or the like. In some embodiments, the advertisement creative input 601 includes still image data, such as banner ads, thumbnails, and/or the like. Input processing module 517 extracts the one or more still images included in the advertisement creative input 601 and includes the one or more still images in the advertisement video data 602.

At step 1003, audio processing module 631 generates audio features 606 based on advertisement audio data 603. In some embodiments, audio processing module 631 extracts an audio transcript from advertisement audio data 603 using an ASR model, such as an LLM-based ASR (e.g., faster-whisper model) or a conventional ASR system. The audio transcript includes the spoken content of advertisement audio data 603 in text form, such as product names, brand mentions, promotional language, disclaimers, and other relevant information. In some embodiments, audio processing module 631 also detects the audio language of advertisement audio data 603 using language detection models, language classification modules, or other similar tools integrated with an ASR pipeline. The detected audio language is encoded as an audio language indicator and included in audio features 606. The audio language can be used to support compliance checks, regional targeting, or multi-language analysis workflows. In some embodiments, audio processing module 631 extracts additional features from advertisement audio data 603, such as speaker diarization (e.g., identifying different speakers), tone or sentiment indicators, timing data that associates specific transcript segments with corresponding time intervals in the advertisement audio data 603, and/or the like.

At step 1004, video keyframe identification module 630 generates video keyframes 604 based on advertisement video data 602. In some embodiments, video keyframe identification module 630 includes, without limitation, video frame sampler 701, hash generator 702, video frame group generator 703, video frame score generator 704, and video keyframe selector 705. In operation, video frame sampler 701 processes advertisement video data 602 and generates one or more video frame samples 710. Hash generator 702 processes video frame samples 710 and generates one or more hash values 711. Video frame group generator 703 processes video frame samples 710 and hash values 711 to generate one or more video frame groups 712. Video frame score generator 704 processes video frame groups 712 and generates one or more video frame scores 713. Video keyframe selector 705 processes video frame scores 713 and generates one or more video keyframes 604. Step 1004 is described in greater detail in conjunction with FIG. 11.

At step 1005, video keyframe processing module 634 generates video keyframe features 605, using multimodal model 521, based on video keyframe 604. In some embodiments, video keyframe processing module 634 includes caption generator 610, text extractor 611, brand logo detector 612, and link detector 613. Caption generator 610 uses multimodal model 521 to process video keyframes 604 and generate one or more video keyframe captions. In some embodiments, caption generator 610 generates a natural language description of the visual content of each video keyframe 604, using a VLM or a LLM included in multimodal model 521 configured to process image data included in video keyframes 604 and generate a textual output included in video keyframe captions. The generated video keyframe captions include key visual elements present in the video keyframes 604, such as products, brand logos, promotional text, scenes, or objects. Text extractor 611 processes video keyframes 604 and generates video keyframe texts. In some embodiments, text extractor 611 applies optical character recognition (OCR) techniques to extract textual content present within each video keyframe 604. The extracted text included in the video keyframe texts includes brand names, product names, promotional slogans, legal disclaimers, pricing information, or any other text visible in video keyframes 604. Brand logo detector 612 processes video keyframes 604 and generates video keyframe brand logos. In some embodiments, brand logo detector 612 applies one or more computer vision models, such as a CNN, a vision transformer, or a logo detection model trained on labeled logo datasets, to detect and recognize brand logos present within each video keyframe 604. The detected brand logos included in video keyframe brand logos include visual representations of brand names, symbols, or trademarks that appear on product packaging, clothing, signage, or other elements within the video keyframes 604. Link detector 613 processes video keyframes 604 and generates one or more video keyframe links. In some embodiments, link detector 613 applies OCR, pattern matching, and natural language processing techniques to identify textual content within video keyframes 604 that includes links or references to external resources. The links include URLs, QR codes, or other types of machine-readable references embedded within the visual content of video keyframes 604. In some embodiments, video keyframe processing module 634 aggregates the video keyframe captions, the video keyframe texts, the video keyframe brand logos, and the video keyframe links into video keyframe features 605. In some embodiments, step 1003 and steps 1004 and 1005 are performed concurrently or sequentially.

At step 1006, video/audio feature generator 516 stores video keyframe features 605 and audio features 606 in video/audio feature data 524.

FIG. 11 sets forth a flow diagram of method steps for generating the video keyframes 604, according to various embodiments. Although the method steps are described in conjunction with the systems of FIGS. 1-9, persons skilled in the art will understand that any system configured to perform the method steps in any order falls within the scope of the present disclosure.

Step 1004 of the method 1000 begins with step 1101, where video frame sampler 701 generates video frame samples 710 based on advertisement video data 602. In some embodiments, video frame sampler 701 extracts video frame samples 710 from advertisement video data 602 at a specified sampling rate or based on scene change detection. For example, video frame sampler 701 can extract video frames at a fixed interval (e.g., one frame per second) or dynamically adjust the sampling rate based on visual content variation within the video stream included in advertisement video data 602. In some embodiments, video frame sampler 701 detects scene transitions, such as changes in background, lighting, or object composition, and prioritizes the extraction of video frames corresponding to the transitions.

At step 1102, hash generator 702 generates hash values 711 based on video frame samples 710. In some embodiments, hash generator 702 applies a pHash algorithm to each video frame sample 710 to generate a corresponding hash value 711 that captures the overall visual appearance of the video frame included in video frame samples 710 in a compact and comparison-friendly form. Perceptual hashes included in hash values 711 encode visual information, such as color distribution, edge patterns, spatial structure, and general image content, in a manner that allows visually similar video frames to be assigned similar hash values 711, even in the presence of minor variations, such as compression artifacts or scaling. For example, hash generator 702 can apply a perceptual hash algorithm, such as aHash or dHash, to generate hash values 711 for video frame samples 710. In some embodiments, hash generator 702 uses a wavelet hash, which applies a wavelet transform to the video frame sample 710 to generate a hash value 711 that is robust to variations in scale, compression, and minor visual distortions.

At step 1103, video keyframe group generator 703 generates video frame groups 712 based on hash values 711 and video frame samples 710. In some embodiments, video keyframe group generator 703 compares hash values 711 associated with video frame samples 710 to identify and group visually similar video frames. In some embodiments, video keyframe group generator 703 applies a similarity threshold to the hash values 711 to determine whether two video frames included in video frame samples 710 should be assigned to the same video frame group 712. For example, video keyframe group generator 703 can compute the Hamming distance between perceptual hash values included in hash values 711 and group together video frames included in video frame samples 710 whose hash values 711 fall within a predefined distance threshold. In some embodiments, video frame group generator 703 computes distance metrics, such as cosine similarity distance, Euclidean distance, and/or the like, to form groups of visually similar frames. In some embodiments, video frame group generator 703 groups together consecutive video frame samples 710 that show substantially the same visual content, such as a static product shot, brand logo, text screen, or consistent scene background.

At step 1104, video frame score generator 704 generates video frame scores 713 based on video frame groups 712. In some embodiments, video frame score generator 704 applies one or more scoring heuristics or machine learning models to assign a relevance score to each video frame included in a video frame group 712. The video frame score 713 includes the degree to which a given video frame is likely to include semantically significant visual content useful for advertisement creative understanding tasks. In some embodiments, video frame score generator 704 computes scores included in video frame scores 713 based on image characteristics, such as the amount of high-frequency visual detail, the presence of text regions as detected by OCR, logo detections, or other saliency cues. For example, video frame score generator 704 can apply a DCT to measure the frequency content of a video frame included in video frame groups 712 and assign higher scores to the video frames with greater visual detail, which are more likely to include relevant information, such as product packaging or on-screen text. In some embodiments, video frame score generator 704 computes image entropy scores, which measure the information density and complexity of the visual content within a video frame included in video frame groups 712. Higher entropy scores typically indicate the presence of diverse visual patterns, edges, or text, whereas low entropy scores indicate blank screens, static backgrounds, or low-information frames. In some embodiments, video frame score generator 704 combines entropy scores with other scoring factors, such as high-frequency content, OCR token density, and logo detection confidence, to generate a composite video frame score 713.

At step 1105, video keyframe selector 705 generates video keyframes 604 based on video frame scores 713 and video frame groups 712. In some embodiments, video keyframe selector 705 selects one or more representative video frames included in each video frame group 712 based on the corresponding video frame scores 713. In some embodiments, video keyframe selector 705 selects the video frame within each video frame group 712 that has the highest video frame score 713. In some embodiments, video keyframe selector 705 applies one or more selection criteria to permit temporal diversity and avoid over-representation of static scenes. For example, video keyframe selector 705 can limit the number of selected video keyframes 604 from consecutive time windows or can enforce a minimum temporal distance between selected video keyframes 604. In some embodiments, video keyframe selector 705 prioritizes video frame groups 712 with high overall scores or greater visual complexity to ensure that video keyframes 604 provide a broad and informative representation of the advertisement creative input 601.

FIG. 12 sets forth a flow diagram of method steps for generating brand alias table 523, according to various embodiments. Although the method steps are described in conjunction with the systems of FIGS. 1-9, persons skilled in the art will understand that any system configured to perform the method steps in any order falls within the scope of the present disclosure.

As shown, the method 1200 begins with step 1201, where brand alias generator 518 receives brand alias prompts 801. In some embodiments, brand alias prompts 801 are received or generated either through automated workflows or through user-defined configurations. In some embodiments, brand alias prompts 801 are automatically generated based on templates that include the standardized brand name and relevant metadata, such as the parent company of the brand or product category. In some embodiments, users or administrators configure or edit brand alias prompts 801 to refine how multimodal model 521 is instructed to generate aliases for specific brands included in brand taxonomy data 522. In some embodiments, brand alias prompts 801 are generated to instruct multimodal model 521 to return likely ways in which each brand included in brand taxonomy data 522 appears or is referenced in natural language, visual text, or spoken audio within advertisement creatives.

At step 1202, brand alias generator 518 generates brand alias table 523, using multimodal model 521, based on brand alias prompts 801 and brand taxonomy data 522. In some embodiments, brand alias generator 518 uses multimodal model 521 to generate a list of alternate names, abbreviations, colloquial references, and other variations for each standardized brand name included in brand taxonomy data 522.

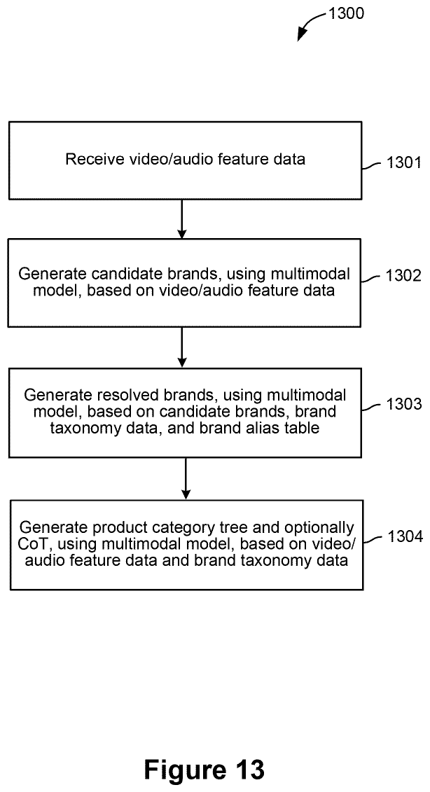

FIG. 13 sets forth a flow diagram of method steps for generating resolved brands 911, product category tree 910, and optionally CoT 912, according to various embodiments. Although the method steps are described in conjunction with the systems of FIGS. 1-9, persons skilled in the art will understand that any system configured to perform the method steps in any order falls within the scope of the present disclosure.

As shown, the method 1300 begins with step 1301, where advertisement creative understanding application receives video/audio feature data 524. In some embodiments, video/audio feature data 524 is generated as described in conjunction with the method 1000.

At step 1301, brand identifier 547 generates candidate brands 902, using multimodal model 521, based on video/audio feature data 524. In some embodiments, brand identifier 547 uses multimodal model 521 to analyze a combination of textual and visual features included in video/audio feature data 524, such as audio transcripts, audio language indicators, video keyframe captions, video keyframe texts, video keyframe brand logos, and video keyframe links. In some embodiments, brand identifier 547 applies prompt-based reasoning using multimodal model 521 to infer one or more candidate brands 902 that are referenced, promoted, or visually shown in advertisement creative input 601. In some embodiments, brand identifier 547 also generates confidence scores or justifications for each candidate brand 902 to indicate the strength of the supporting evidence.

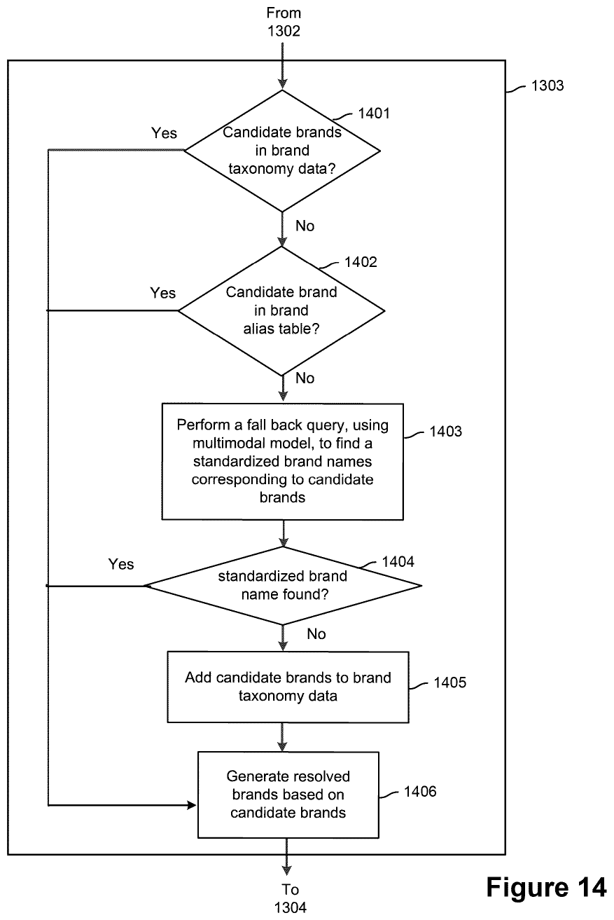

At step 1303, brand resolver 549 generates resolved brands using multimodal model 521, based on candidate brands 902, brand taxonomy data 522, and brand alias table 523. In some embodiments, brand resolver 549 applies a multi-stage entity resolution workflow to map each candidate brand 902 to a corresponding standardized brand name in brand taxonomy data 522. The entity resolution process begins by determining whether candidate brand 902 exactly matches a standardized brand name already included in brand taxonomy data 522. Whenever such a match is found, brand resolver 549 generates a resolved brand 911 corresponding to the matched standardized brand. Whenever candidate brand 902 is not found in brand taxonomy data 522, brand resolver 549 next determines whether candidate brand 902 matches any known alias stored in brand alias table 523. In some embodiments, brand alias table 523 includes a list of alternate names and forms of reference for each standardized brand, generated through prior use of brand alias prompts with multimodal model 521. Whenever candidate brand 902 matches an alias included in brand alias table 523, brand resolver 549 generates resolved brand 911 using the corresponding brand alias. Whenever candidate brand 902 is not matched in either brand taxonomy data 522 or brand alias table 523, brand resolver 549 performs a fallback query using multimodal model 521. In some embodiments, brand resolver 549 constructs a prompt that includes candidate brand 902 and a contextual list of standardized brands from brand taxonomy data 522 and queries multimodal model 521 to determine whether the candidate brand 902 can be semantically mapped to an existing standardized brand. Whenever no standardized brand name can be found using any of the above steps, brand resolver 549 adds candidate brand 902 as a suggested new brand entry to brand taxonomy data 522. In some embodiments, suggested new brands are queued for human review and taxonomy enrichment. In some embodiments, resolved brand 911 include metadata, such as a confidence score and a justification trace generated by multimodal model 521. The justification trace includes the reasoning or contextual signals used to resolve the brand, providing transparency and enabling downstream auditing or human-in-the-loop review. Step 1303 is described in greater detail in conjunction with FIG. 14.

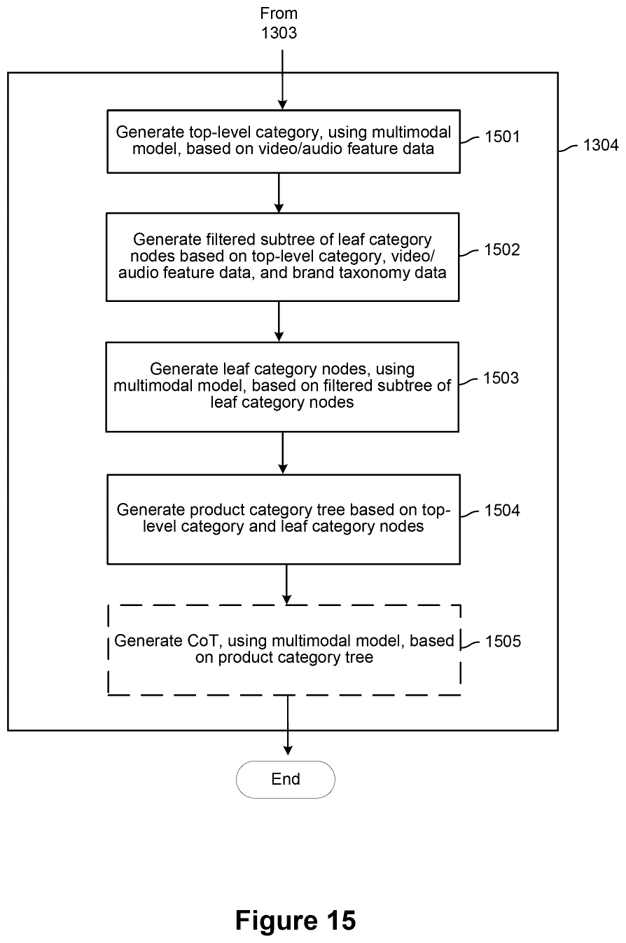

At step 1304, product category tree identifier 548 generates product category tree 910 and optionally CoT 912, using multimodal model 521, based on video/audio feature data 524 and brand taxonomy data 522. In some embodiments, product category tree identifier 548 applies a hierarchical classification workflow that uses multimodal model 521 to generate a structured product category tree 910 for each advertisement creative input 601. The classification process begins by using multimodal model 521 to generate a top-level category for the advertisement creative input 601, based on video/audio feature data 524. In some embodiments, the top-level category is selected from a predefined set of high-level categories, such as “Apparel,” “Consumer Electronics,” “Beverages,” “Financial Services,” or “Automotive.” Next, product category tree identifier 548 generates a filtered subtree of leaf category nodes based on the selected top-level category and brand taxonomy data 522. In some embodiments, the filtered subtree includes the leaf categories that are valid children of the selected top-level category, thereby reducing ambiguity and improving classification accuracy. Based on the selected top-level category and one or more leaf category nodes, product category tree identifier 548 generates product category tree 910. In some embodiments, product category tree identifier 548 optionally generates CoT 912, where multimodal model 521 is used to generate a chain-of-thought reasoning trace explaining the rationale behind the selected categories. Step 1304 is described in greater detail in conjunction with FIG. 15.

FIG. 14 sets forth a flow diagram of method steps for generating resolved brands 911, according to various embodiments. Although the method steps are described in conjunction with the systems of FIGS. 1-9, persons skilled in the art will understand that any system configured to perform the method steps in any order falls within the scope of the present disclosure.

As shown, step 1303 of the method 1300 begins with step 1401, where brand resolver 549 checks whether one or more candidate brands 602 are included in brand taxonomy data 522. In some embodiments, brand resolver 549 determines whether candidate brand 902 exactly matches a standardized brand name already included in brand taxonomy data 522. Whenever brand resolver 549 determines that at least one or more candidate brands 602 are included in brand taxonomy data 522, step 1303 proceeds to step 1406. Whenever brand resolver 549 determines one or more candidate brands 602 are not included in brand taxonomy data 522, step 1303 proceeds to step 1402.

At step 1402, brand resolver 549 checks whether one or more candidate brands 602 are included in brand alias table 523. In some embodiments, brand resolver 549 determines whether at least one or more candidate brand 902 matches any known alias stored in brand alias table 523. In some embodiments, brand alias table 523 includes a list of alternate names and forms of reference for each standardized brand, generated through prior use of brand alias prompts with multimodal model 521. Whenever brand resolver 549 determines that at least one or more candidate brands 602 are included in brand alias table 523, step 1303 proceeds to step 1406. Whenever brand resolver 549 determines one or more candidate brands 602 are not included in brand alias table 523, step 1303 proceeds to step 1403.

At step 1403, brand resolver 549 performs a fall back query, using multimodal model 521, to find standardized brand names corresponding to candidate brands 602. In some embodiments, brand resolver 549 constructs a prompt that includes candidate brand 902 and a contextual list of standardized brands from brand taxonomy data 522 and queries multimodal model 521 to determine whether the candidate brand 902 can be semantically mapped to an existing standardized brand.

At step 1404, brand resolver 549 determines whether a standardized brand name is found. Whenever brand resolver 549 determines that at least one standardized brand name is found, step 1303 proceeds to step 1406. Whenever brand resolver 549 determines that no standardized brand name is found, step 1303 proceeds to step 1405.

At step 1405, brand resolver 549 adds candidate brands 602 to brand taxonomy data 522. In some embodiments, brand resolver 549 adds candidate brand 902 as a suggested new brand entry to brand taxonomy data 522. In some embodiments, suggested new brands are queued for human review and taxonomy enrichment.

At step 1406, brand resolver 549 generates resolved brands 911 based on candidate brands 602. In some embodiments, resolved brand 911 include metadata, such as a confidence score and a justification trace generated by multimodal model 521. The justification trace includes the reasoning or contextual signals used to resolve the brand, providing transparency and enabling downstream auditing or human-in-the-loop review.

FIG. 15 sets forth a flow diagram of method steps for generating product category tree, and optionally CoT, according to various embodiments. Although the method steps are described in conjunction with the systems of FIGS. 1-9, persons skilled in the art will understand that any system configured to perform the method steps in any order falls within the scope of the present disclosure.

As shown, step 1304 of the method 1300 begins with step 1501, wherein product category tree identifier 548 generates top-level category, using multimodal model 521, based on video/audio feature data 524. In some embodiments, product category tree identifier 548 uses multimodal model 521 to generate a top-level category for the advertisement creative input 601, based on video/audio feature data 524. In some embodiments, the top-level category is selected from a predefined set of high-level categories, such as “Apparel,” “Consumer Electronics,” “Beverages,” “Financial Services,” “Automotive,” and/or the like.

At step 1502, product category tree identifier 548 generates filtered subtree of leaf category nodes based on the top-level category, video/audio feature data 524, and brand taxonomy data 522. In some embodiments, the filtered subtree includes the leaf categories that are valid children of the selected top-level category, thereby reducing ambiguity and improving classification accuracy.

At step 1503, product category tree identifier 548 generates leaf category nodes, using multimodal model 521, based on the filtered subtree of leaf category nodes.

At step 1504, product category identifier 548 generates product category tree 910 based on the top-level category and leaf category nodes. In some embodiments, product category tree 910 includes a structured hierarchy of categories that reflects the content of the advertisement creative input 601, permitting accurate reporting and policy enforcement. In some embodiments, to further improve the accuracy of product category classification, brand taxonomy data 522 is pre-processed using multimodal model 521 to generate model-friendly versions of category names and category definitions. In some embodiments, one or more category names do not fully capture the scope of the category, potentially leading to confusion for multimodal model 521. To address category names that do not fully capture the scope of the category, a preprocessing step using multimodal model 521 is performed to generate model-friendly category names based on human-curated definitions. In some embodiments, one or more category definitions could confuse multimodal model 521 due to ambiguous or overly descriptive wording. A preprocessing step is performed to revise category definitions into model-friendly, instruction-based formats, using the path of the category in the taxonomy tree and category node name. In some embodiments, both the model-friendly category names and revised category definitions are generated as one-time preprocessing steps, and the results are persisted in brand taxonomy data 522. In some embodiments, product category tree identifier 548 receives a pre-generated filtered subtree of leaf category nodes derived from the brand taxonomy data 522 and based on a previously determined top-level category. The filtered subtree is generated during a preprocessing phase and cached for runtime efficiency. Accordingly, during inference, product category tree identifier 548 bypasses filtered subtree of leaf category nodes generation and proceed directly to generating leaf category nodes using the cached filtered subtree of leaf category nodes. In some embodiments, steps 1503 and 1504 are skipped during runtime, with the corresponding outputs retrieved from pre-generated data.

At step 1505, product category tree identifier 548 optionally generates CoT 912, using multimodal model 521, based on product category tree 910. In some embodiments, product category tree identifier 548 optionally generates CoT 912, where multimodal model 521 is used to generate a chain-of-thought reasoning trace explaining the rationale behind the selected categories included in product category tree 910.

In sum, techniques are disclosed for advertisement creative understanding based on machine learning models. In some embodiments, the disclosed techniques include an input processing module that processes an advertisement creative input and generates advertisement video data and advertisement audio data. A video/audio feature generator processes the advertisement video data and the advertisement audio data and generates video/audio feature data. The video/audio feature generator includes a video keyframe identification module, a video keyframe processing module, and an audio processing module. The video keyframe identification module processes advertisement video data and generates one or more video keyframes. The video keyframe processing module uses a multimodal model, which is a machine learning model, to process the video keyframes and generate video keyframe features stored in the video/audio feature data. In some embodiments, the video keyframe processing module includes a caption generator, a link detector, a text detector, and a brand logo detector. The caption generator uses the multimodal model, such as a vision-language model, to process the video keyframes and generates one or more video keyframe captions describing the one or more video keyframes. The link detector processes the video keyframes and generates one or more video keyframe links, such as links available through quick response (QR) codes. The text detector processes the video keyframes and generates one or more video keyframe texts by extracting texts from video keyframes. The brand logo detector processes the video keyframes and generates video keyframe brand logos by detecting one or more brand logos in the video keyframes. The video keyframe processing module aggregates the video keyframe captions, the video keyframe links, the video keyframe texts, and the video keyframe brand logos and generates the video keyframe features stored in the video/audio feature data. The audio processing module processes advertisement audio data and generates audio features, such as audio language and audio transcript stored in the video/audio feature data. A brand alias generator uses the multimodal model to process one or more brand alias prompts received via one or more I/O devices and a brand taxonomy data (e.g., a structured list of standardized brand names and identifiers) and generates a brand alias table (e.g., alternate forms or common misspellings of brand names). An advertisement creative understanding application then uses the multimodal model, the brand alias table, and the brand taxonomy data to process the video/audio feature data to generate a product category tree, one or more resolved brands, and optionally a chain-of-thought (CoT).

In some embodiments, the keyframe identification module includes a video frame sampler, a hash generator, a video frame group generator, a video frame score generator, and a video keyframe selector. The video frame sampler processes the advertisement video data and generates one or more video frame samples at specified intervals or based on scene change detection. The hash generator processes the video frame samples and generates one or more hash values, such as perceptual hash values, used to detect visual similarity across frames. The video frame group generator processes the video frame samples and the corresponding hash values to cluster visually similar frames into one or more video frame groups. The video frame score generator processes each video frame group using one or more heuristics or learned models, such as frame frequency, OCR token density, or visual salience, to compute one or more video frame scores representing the informational relevance of each video frame included in the video frame group. The video keyframe selector processes the video frame scores and the video frame groups and generates the video keyframes.

In some embodiments, the advertisement video understanding application includes a brand identifier, a product category tree identifier, and a brand resolver. The brand identifier uses the multimodal model to process the video/audio feature data and generate one or more candidate brands. The brand resolver uses the multimodal model to process the one or more candidate brands, the brand taxonomy data, and the brand alias table to generate resolved brands. In some embodiments, the brand resolver also adds one or more brand names to the brand taxonomy data when the one or more candidate brands are not included in the brand taxonomy data and the brand alias table and are not found by the multimodal model as a standardized brand name. The product category tree identifier uses the multimodal model to process video/audio feature data and the brand taxonomy data and generate the product category tree.

At least one technical advantage of the disclosed techniques relative to the prior art is that the disclosed techniques enable advertisement creative understanding to be performed in an automated and scalable manner through the use of multimodal machine learning models. This approach reduces reliance on manual reviews while increasing efficiency and consistency. The disclosed techniques involve the automated extraction of visual and audio features from advertisement creatives, including video keyframes, audio transcripts, brand logos, and textual elements. A multimodal model is employed to perform brand identification, brand resolution, and product category classification with a high degree of accuracy. Consequently, the disclosed techniques permit the processing of large volumes of diverse advertisement formats in a consistent and repeatable manner, thereby reducing human intervention, processing time, and the potential for human error. Additionally, the disclosed techniques support rapid adaptation to evolving content taxonomies and new product categories by employing large language models to dynamically interpret taxonomy updates and generate model-friendly category names and definitions. These technical advantages provide one or more technological improvements over prior art approaches.
1. In some embodiments, a computer-implemented method for generating advertisement video features and advertisement audio features comprises receiving an advertisement creative via one or more I/O devices, generating, based on the advertisement creative, audio data and video data, and generating, based on the audio data and the video data, and using a machine learning model, one or more video features and one or more audio features.
2. The computer-implemented method of clause 1, wherein the machine learning model comprises at least one of a large language model or a vision-language model.
3. The computer-implemented method of clauses 1 or 2, wherein generating the one or more video features and the one or more audio features comprises generating, based on the video data, one or more video keyframes, generating, based on the one or more video keyframes and using the machine learning model, one or more video keyframe features, and generating, based on the audio data, the one or more audio features.
4. The computer-implemented method of any of clauses 1-3, wherein the one or more video keyframe features comprises at least one of one or more video keyframe texts, one or more video keyframe captions, one or more video keyframe brand logos, or one or more video keyframe links.
5. The computer-implemented method of any of clauses 1-4, wherein the one or more audio features comprises at least one of an audio transcript or an audio language.
6. The computer-implemented method of any of clauses 1-5, wherein generating the one or more audio features comprises using an automatic speech recognition (ASR) model.
7. The computer-implemented method of any of clauses 1-6, wherein the ASR model is a faster-whisper model.
8. The computer-implemented method of any of clauses 1-7, wherein generating the one or more video features and the one or more audio features comprises generating, based on one or more video keyframes, one or more video keyframe texts using an optical character recognition (OCR) technique.
9. The computer-implemented method of any of clauses 1-8, further comprising generating, based on the one or more audio features, the one or more video features, a brand alias table, and brand taxonomy data, and using the machine learning model, at least one of one or more resolved brands, a product category tree, and a chain-of-thought (CoT).
10. The computer-implemented method of any of clauses 1-9, wherein the brand alias table is generated using the machine learning model and is based on one or more user alias prompts and the brand taxonomy data.
11. In some embodiments, one or more non-transitory computer-readable media store instructions that, when executed by one or more processors, cause the one or more processors to perform the steps of receiving an advertisement creative via one or more I/O devices, generating, based on the advertisement creative, audio data and video data, and generating, based on the audio data and the video data, and using a machine learning model, one or more video features and one or more audio features.
12. The one or more non-transitory computer-readable media of clause 11, wherein the machine learning model comprises at least one of a large language model or a vision-language model.
13. The one or more non-transitory computer-readable media of clauses 11 or 12, wherein generating the one or more video features and the one or more audio features comprises generating, based on the video data, one or more video keyframes, generating, based on the one or more video keyframes and using the machine learning model, one or more video keyframe features, and generating, based on the audio data, the one or more audio features.
14. The one or more non-transitory computer-readable media of any of clauses 11-13, wherein the one or more video keyframe features comprises at least one of one or more video keyframe texts, one or more video keyframe captions, one or more video keyframe brand logos, or one or more video keyframe links.
15. The one or more non-transitory computer-readable media of any of clauses 11-14, wherein the one or more video keyframe links comprises at least one of one or more Uniform Resource Locators (URLs) and one or more quick response (QR) codes.
16. The one or more non-transitory computer-readable media of any of clauses 11-15, wherein the instructions further cause the one or more processors to perform the step of generating, based on one or more user prompts and brand taxonomy data, and using the machine learning model, a brand alias table.
17. The one or more non-transitory computer-readable media of any of clauses 11-16, wherein the instructions further cause the one or more processors to perform the step of pre-processing the brand taxonomy data using the machine learning model to generate one or more model-friendly versions of one or more category names.
18. The one or more non-transitory computer-readable media of any of clauses 11-17, wherein the instructions further cause the one or more processors to perform the step of generating, based on the one or more audio features, the one or more video features, a brand alias table, and brand taxonomy data, and using the machine learning model, at least one of one or more resolved brands, a product category tree, and a CoT.
19. The one or more non-transitory computer-readable media of any of clauses 11-18, wherein generating one or more video keyframes comprises generating, based on video data, one or more video frame samples, generating, based on the one or more video frame samples, one or more hash values, generating, based on the one or more hash values and the one or more video frame samples, one or more video frame groups, generating, based on the one or more video frame groups, one or more video frame scores, and generating, based on the one or more video frame scores and the one or more video frame groups, the one or more video keyframes.
20. In some embodiments, a system comprises one or more memories storing instructions, and one or more processors that are coupled to the one or more memories and, when executing the instructions, are configured to receive an advertisement creative via one or more I/O devices, generate, based on the advertisement creative, audio data and video data, and generate, based on the audio data and the video data, and using a machine learning model, one or more video features and one or more audio features.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may include a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating advertisement video features and advertisement audio features, the method comprising:
receiving an advertisement creative via one or more I/O devices;
generating, based on the advertisement creative, audio data and video data; and
generating, based on the audio data and the video data, and using a machine learning model, one or more video features and one or more audio features.

2. The computer-implemented method of claim 1, wherein the machine learning model comprises at least one of a large language model or a vision-language model.

3. The computer-implemented method of claim 1, wherein generating the one or more video features and the one or more audio features comprises:
generating, based on the video data, one or more video keyframes;
generating, based on the one or more video keyframes and using the machine learning model, one or more video keyframe features; and
generating, based on the audio data, the one or more audio features.

4. The computer-implemented method of claim 3, wherein the one or more video keyframe features comprises at least one of one or more video keyframe texts, one or more video keyframe captions, one or more video keyframe brand logos, or one or more video keyframe links.

5. The computer-implemented method of claim 3, wherein the one or more audio features comprises at least one of an audio transcript or an audio language.

6. The computer-implemented method of claim 3, wherein generating the one or more audio features comprises using an automatic speech recognition (ASR) model.

7. The computer-implemented method of claim 6, wherein the ASR model is a faster-whisper model.

8. The computer-implemented method of claim 1, wherein generating the one or more video features and the one or more audio features comprises generating, based on one or more video keyframes, one or more video keyframe texts using an optical character recognition (OCR) technique.

9. The computer-implemented method of claim 1, further comprising generating, based on the one or more audio features, the one or more video features, a brand alias table, and brand taxonomy data, and using the machine learning model, at least one of one or more resolved brands, a product category tree, and a chain-of-thought (CoT).

10. The computer-implemented method of claim 9, wherein the brand alias table is generated using the machine learning model and is based on one or more user alias prompts and the brand taxonomy data.

11. One or more non-transitory computer-readable media storing instructions that, when executed by one or more processors, cause the one or more processors to perform the steps of:
receiving an advertisement creative via one or more I/O devices;
generating, based on the advertisement creative, audio data and video data; and
generating, based on the audio data and the video data, and using a machine learning model, one or more video features and one or more audio features.

12. The one or more non-transitory computer-readable media of claim 11, wherein the machine learning model comprises at least one of a large language model or a vision-language model.

13. The one or more non-transitory computer-readable media of claim 11, wherein generating the one or more video features and the one or more audio features comprises:
generating, based on the video data, one or more video keyframes;
generating, based on the one or more video keyframes and using the machine learning model, one or more video keyframe features; and
generating, based on the audio data, the one or more audio features.

14. The one or more non-transitory computer-readable media of claim 13, wherein the one or more video keyframe features comprises at least one of one or more video keyframe texts, one or more video keyframe captions, one or more video keyframe brand logos, or one or more video keyframe links.

15. The one or more non-transitory computer-readable media of claim 14, wherein the one or more video keyframe links comprises at least one of one or more Uniform Resource Locators (URLs) and one or more quick response (QR) codes.

16. The one or more non-transitory computer-readable media of claim 11, wherein the instructions further cause the one or more processors to perform the step of generating, based on one or more user prompts and brand taxonomy data, and using the machine learning model, a brand alias table.

17. The one or more non-transitory computer-readable media of claim 16, wherein the instructions further cause the one or more processors to perform the step of pre-processing the brand taxonomy data using the machine learning model to generate one or more model-friendly versions of one or more category names.

18. The one or more non-transitory computer-readable media of claim 11, wherein the instructions further cause the one or more processors to perform the step of generating, based on the one or more audio features, the one or more video features, a brand alias table, and brand taxonomy data, and using the machine learning model, at least one of one or more resolved brands, a product category tree, and a CoT.

19. The one or more non-transitory computer-readable media of claim 11, wherein generating one or more video keyframes comprises:
generating, based on video data, one or more video frame samples;
generating, based on the one or more video frame samples, one or more hash values;
generating, based on the one or more hash values and the one or more video frame samples, one or more video frame groups;
generating, based on the one or more video frame groups, one or more video frame scores; and
generating, based on the one or more video frame scores and the one or more video frame groups, the one or more video keyframes.

20. A system, comprising:
one or more memories storing instructions, and
one or more processors that are coupled to the one or more memories and, when executing the instructions, are configured to:
receive an advertisement creative via one or more I/O devices,
generate, based on the advertisement creative, audio data and video data, and
generate, based on the audio data and the video data, and using a machine learning model, one or more video features and one or more audio features.
